(19) United States
(12) Patent Application Publication
(10) Pub. No.: US 2024/0356663 A1
(43) Pub. Date: Oct. 24, 2024

(54) METHODS AND APPARATUS FOR DETERMINING ABOVE GROUND COVERAGE OF A MOBILE TELECOMMUNICATIONS NETWORK

(71) Applicant: VODAFONE GROUP SERVICES LIMITED, Newbury, Berkshire (GB)

(72) Inventors: Adriano VLAD, Newbury, Berkshire (GB); Fiona LAU, Newbury, Berkshire (GB); Jindong HOU, Newbury, Berkshire (GB); Victor FERNÁNDEZ, Newbury, Berkshire (GB)

(21) Appl. No.: 18/685,709

(22) PCT Filed: Aug. 16, 2022
(86) PCT No.: PCT/GB2022/052126

§ 371 Date: Feb. 22, 2024

(30) Foreign Application Priority Data
Aug. 23, 2021 (GB) 2112080.3

(51) Int. Cl. H04B 17/391; H04W 64/00; H04W 84/06

(52) U.S. Cl. CPC H04B 17/3913; H04W 64/003; H04W 84/06

(57) ABSTRACT

A method of determining above ground coverage of a mobile telecommunications network. Data is received which is representative of coverage of the mobile telecommunications network at a plurality of ground based locations. A location above ground is identified for which coverage of the mobile telecommunications network is to be determined. A subset of the data representative of coverage at the plurality of ground based locations is selected, where the subset comprises data representative of coverage of the mobile telecommunications network at a subset of the ground based locations. Selecting the subset comprises selecting the subset of the ground based locations in dependence on their location relative to the identified location above ground. A property of the identified location above ground and the selected subset of data representative of coverage at ground based locations are provided as inputs to a prediction model. The prediction model is configured through training, to determine coverage of a mobile telecommunications network at locations above ground in dependence on data representative of coverage of the mobile telecommunications network at one or more ground based locations. The prediction model is implemented to generate an output in dependence on the provided inputs, wherein the output of the model is representative of the coverage of the mobile telecommunications network at the identified location above ground.

### FIELD OF THE INVENTION

The present disclosure relates to methods, apparatus and software for determining above ground coverage of a mobile telecommunications network. The present disclosure further relates to apparatus, methods and software for training a prediction model for determining above ground coverage of a mobile telecommunications network.

### BACKGROUND

Mobile telecommunications networks, such as a cellular network, typically provide network connectivity to devices situated substantially at ground level. For example, typically the vast majority of devices which connect to a mobile telecommunications network are situated substantially at ground level, such as devices used by users situated outside at ground level or inside ground based buildings. Consequently considerations of the coverage provided by a mobile telecommunications network are typically focussed on the coverage provided substantially at ground level.

Furthermore, given the large number of devices connecting to a network whilst situated substantially at ground level, it is relatively easy for measurements to be made which are representative of the coverage provided by the network at ground level. For example, mobile devices (which are typically situated substantially at ground level) may regularly make measurements which are indicative, for example, of the power of signals received from a network component (e.g. a base station), the quality of signals received from a network component, and/or a propagation time for signals exchanged between a network component and the device. Such measurements may be reported to the network and may be used to provide an indication of the coverage provided by the network at ground level. For example, measurements made by devices operating substantially at ground level may be used to determine factors such as a geographic extent of coverage provided by the network, signal power provided at different geographic locations, signal quality provided at different geographic locations and/or any other factors relevant to the provision of coverage by the network.

Whilst the vast majority of devices which connect to mobile telecommunications networks are typically situated substantially at ground level, increasingly utility is being found for mobile network connected devices operating above ground level. One such example utility is the use of network connected drones which fly at altitude (i.e. above ground level). A network connected drone may be able to fly freely and without the need to maintain radio communication with a single control device. For example, unlike traditional drones, it may not be necessary to maintain visual line of sight between a network connected drone and a ground based control device, since control and communication may be provided through connection to a mobile telecommunications network.

For control and/or monitoring of such network connected drones it may be useful to have an indication of the coverage of a mobile telecommunications network at locations above ground level (e.g. locations at which airborne devices may seek connection to the network). For example, it may be desirable to have knowledge of the geographic regions at which reliable network coverage is provided above ground level and, by extension, geographic regions at which little or no reliable network coverage is available. Such knowledge may be used to limit the geographic regions in which a drone is operated in order to avoid a loss of network connectivity.

Knowledge of the coverage provided by a mobile telecommunications network at above ground locations, may additionally or alternatively be used to determine the position of airborne devices using network data alone, for example, as an alternative to using the Global Positioning System (GPS). For example, if one or more measures of network coverage (e.g. signal power, signal quality etc.) as a function of location above ground are known, then measurements of corresponding properties taken by an airborne device may be used to determine its location.

Whilst example applications of knowledge of network coverage at above ground locations have been provided above, it will be understood that there may be additional and/or alternative applications of such knowledge.

Given the limited use of network connected devices above ground level, far fewer measurements representative of network coverage above ground level (relative to measurements representative of network coverage substantially at ground level) are made by devices operating in a network. Consequently insufficient measurements may be available to directly determine network coverage at a sufficient number of locations above ground level.

In order to determine network coverage at above ground locations, dedicated flights of airborne devices may be made to directly measure network coverage. However such flights are typically expensive, time consuming and provide measurements over a limited geographic range.

It is in this context that the subject matter contained in the present application has been devised.

### SUMMARY OF THE INVENTION

It has been found that measurements of network coverage made at ground based locations can be used to determine corresponding measures of network coverage at above ground locations. For example, measurements made by network devices (e.g. of signals transmitted over the network and received at the network devices) operating at ground based locations may be used to determine one or more measures of network coverage at above ground locations in the vicinity of the measurements made at ground based locations. In particular it has been found that measurements made at above ground locations and ground based locations may be used to train a prediction model for determining network coverage at above ground locations based on ground based measurements.

According to a first aspect of the present disclosure there is provided a computer implemented method of determining above ground coverage of a mobile telecommunications network, the method comprising: receiving data representative of coverage of the mobile telecommunications network at a plurality of ground based locations; identifying a location above ground for which coverage of the mobile telecommunications network is to be determined; selecting a subset of the data representative of coverage at the plurality of ground based locations, wherein the subset comprises data representative of coverage of the mobile telecommunications network at a subset of the ground based locations and wherein selecting the subset comprises selecting the subset of the ground based locations in dependence on their location relative to the identified location above ground; providing a property of the identified location above ground and the selected subset of data representative of coverage at ground based locations as inputs to a prediction model, configured through training, to determine coverage of a mobile telecommunications network at locations above ground in dependence on data representative of coverage of the mobile telecommunications network at a one or more ground based locations; and implementing the prediction model to generate an output in dependence on the provided inputs, wherein the output of the model is representative of the coverage of the mobile telecommunications network at the identified location above ground.

The plurality of ground based locations may comprise locations which are located substantially at ground level. For example, the plurality of ground based locations may include locations substantially at ground level (e.g. locations at which ground based users may operate a device) and/or locations inside ground based buildings. For example, the plurality of ground based locations may include locations at which a device may be supported by a ground based building. The plurality of ground based locations may include locations which are above the local ground level but are still ground based. For example, the plurality of ground based locations may include one or more locations supported by a ground based building such as a multi-storey ground based building.

The location above ground may comprise a location which is not accessible from the ground or a ground based structure, or other object. For example, the location above ground may comprise a location in the air which is accessible via an airborne platform, such as a drone.

The mobile telecommunications network may comprise a cellular network. The network may include a plurality of base stations. Each base station may comprise at least one antenna configured to exchange communications (e.g. radio frequency signals) with terminals situated within a geographical coverage area (e.g. a cell) serviced by the base station over an air interface.

The data representative of coverage of the mobile telecommunications network may comprise data which is indicative of one or more properties of network coverage provided at the relevant location. For example, the data representative of coverage of the mobile telecommunications network may comprise data which is indicative of a signal power and/or quality associated with the network which is received at the relevant location. A signal power and/or quality associated with the network which is received at the relevant location may comprise a power and/or quality of a signal which is transmitted by a network component, such as a base station, and is received at the relevant location. The data representative of coverage of the mobile telecommunications network may be based on measurements of signal received over the mobile telecommunications network. For example, the data representative of coverage of the mobile telecommunications network at a plurality of ground based locations may be based on measurements of signal received at one or more ground based locations (having been transmitted over the mobile telecommunications network, e.g. from a base station).

The output of the model which is representative of the coverage of the mobile telecommunications network at the identified location above ground may comprise at least one property which corresponds to at least one property on which the data representative of coverage of the mobile telecommunications network at a plurality of ground based locations is based. For example, the output of the model may comprise a property of received signal at the identified location (e.g. received signal power and/or received signal quality). Correspondingly the data representative of coverage of the mobile telecommunications network at a plurality of ground based locations may be at least based on a property of received signal at the plurality of ground based locations. For example, the data representative of coverage of the mobile telecommunications network at the plurality of ground based locations may be based on measurements of received signal at the plurality of ground based locations.

The property of the identified location above ground which is provided as an input to the prediction model may comprise the altitude of the identified location above ground. Additionally or alternatively, the property of the identified location above ground which is provided as an input to the prediction model may comprise at least one of the latitude and longitude of the identified location above ground.

As described above, the selected subset of the data representative of coverage at the plurality of ground based locations comprises data representative of coverage of the mobile telecommunications network at a subset of the ground based locations. The subset of ground based locations may comprise one or more of the plurality of ground based locations. That is, in some examples, the subset may comprise a single ground based location. In other examples, the subset may comprise a plurality of ground based locations.

The prediction model may comprise a regression model. For example, the output of the prediction model may comprise one or more numerical values representative of the coverage of the mobile telecommunications network at the identified location above ground. The one or more numerical values representative of the coverage of the mobile telecommunications network may, for example, include a measure of a received signal power, a received signal quality and/or a timing advance associated with the mobile telecommunications network.

The prediction model may comprise a classification model. For example, the output of the prediction model may comprise one or more classifications representative of coverage of the mobile telecommunications network at the identified location above ground. The one or more classifications may comprise qualitive labels representative of coverage of the mobile telecommunications network. Such classifications may, for example, include labels such as low, medium, high and/or bad, medium, good etc. Such labels may be associated with a specific measure of network coverage such as signal power and/or signal quality or may provide a more general classification of network coverage.

The prediction model may comprise a machine learning model. For example, the prediction model may be trained and/or implemented using any suitable machine learning algorithm. Examples, of such suitable algorithms may, for example, include a K-nearest neighbour algorithm, a linear prediction algorithm, a support vector machine (e.g. a support-vector clustering algorithm), a decision tree algorithm, a random forest algorithm, an adaptive boosting (AdaBoost) algorithm, a gradient boosting algorithm, a voting algorithm and/or a stacking algorithm. In some examples, the prediction model may comprise an artificial neural network.

Selecting the subset of the ground based locations in dependence on their location relative to the identified location above ground may comprise selecting a subset of N ground based locations which are the N closest of the plurality of ground based locations to the identified location above ground, wherein N is an integer equal to or greater than 1.

The method may comprise determining a measure of distance between the identified location above ground and each of the ground based locations. The measure of distance may comprise a direct distance (i.e. the shortest distance) between a ground based location and the location above ground. The measure of distance may comprise a distance between a ground based location and a position on the ground closest to the identified above ground location. The position on the ground closest to the identified above ground location may comprise a position on the ground having substantially the same latitude and longitude as the identified above ground location.

The measure of distance may be determined for each of the ground based locations relative to the identified location above ground. The subset of ground based locations may be selected as the N ground based locations having the smallest measure of distance to the identified location above ground. That is, the selected subset of ground based locations may represent the N ground based locations which are closest to the identified location above ground. N may be any suitable integer equal to or above 1. For example, N may be 1, 2, 3, 4, 5, 6, 7 . . . etc.

Selecting the subset of the ground based locations in dependence on their location relative to the identified location above ground may comprise selecting all of the ground based locations which are positioned within a distance threshold of the identified location above ground.

The method may comprise determining a measure of distance between the identified location above ground and each of the ground based locations. The measure of distance may comprise a direct distance (i.e. the shortest distance) between a ground based location and the location above ground. The measure of distance may comprise a distance between a ground based location and a position on the ground closest to the identified above ground location. The position on the ground closest to the identified above ground location may comprise a position on the ground having substantially the same latitude and longitude as the identified above ground location.

The measure of distance may be determined for each of the ground based locations relative to the identified location above ground. The subset of ground based locations may be selected as ground based locations whose measure of distance to the identified location above ground is less than a distance threshold. The number of ground based locations included in the subset may be different for different identified locations above ground and may depend on how many ground based locations are situated in relative proximity to the identified location above ground. For example, the number of ground based locations included in the subset may be one or greater than 1.

The data representative of coverage of the mobile telecommunications network at a plurality of ground based locations may be based on measurements of received signal measured at one or more ground based locations. The received signal may be transmitted over the mobile telecommunications network. The received signal may be received at and measured by one or more devices (e.g. terminals) situated at ground based locations. The received signal may be transmitted by a base station forming part of the mobile telecommunications network. In some examples, the received signal may be received by and measured by a base station situated at a ground based location. In such examples, the received signal may be transmitted by another base station or may be transmitted by another device operating in the network such as a terminal. Measurements of received signal transmitted over the network depend on propagation of the signal between at least two devices operating in the network. Measurements of received signal therefore capture more information regarding network coverage than, for example, properties such as a transmission power of a signal transmitted from a base station (which does not include any information on how the signal propagates through a network coverage area).

The data representative of coverage of the mobile telecommunications network at a plurality of ground based locations may be based on measurements indicative of coverage of the mobile telecommunications made at a plurality of ground based locations. The measurements indicative of coverage of the mobile telecommunications network made at a plurality of ground based locations, may comprise measurements of a received signal made at a ground based location.

The measurements may, for example, be made by terminals operating in the network. For example, the terminals may connect to or otherwise communicate over the mobile telecommunications network whilst situated at ground based locations. As part of the operation of the terminals at the ground based locations, measurements may be made which are indicative of the coverage provided by the mobile telecommunications network. For example, a terminal may measure one or more reference signals transmitted over the network (e.g. by a base station forming part of the network) and received at the terminal. One or more properties indicative of the coverage provided by the mobile telecommunications network may be determined based on such measurements.

The data representative of coverage of the mobile telecommunications network may comprise measurements made at a plurality of ground based locations. The data representative of coverage of the mobile telecommunications network may comprise one or more properties determined in dependence on measurements made at a plurality of ground based locations. The plurality of ground based locations at which the measurements are made may be the same as the ground based locations. Additionally or alternatively, at least some of the plurality of ground based locations at which measurements are made may be different to the ground based locations. For example, measurements made at different ground based locations may be used to determine (e.g. through extrapolation) data representative of network coverage at the ground based locations. The measurements may comprise measurements of a received signal at a ground based location.

The prediction model may be configured through supervised training using a plurality of training data records, the plurality of training data records being derived from measurements indicative of the coverage of a mobile telecommunications made at both ground based and above ground locations.

Each training data record may be associated with a location above ground and may comprise data representative of the coverage of a mobile telecommunications network at the location above ground and data representative of coverage of the mobile telecommunications at ground based locations selected for the location above ground. The data representative of the coverage of a mobile telecommunications network may be derived from measurements made at above ground and ground based locations. The measurements made at above ground and/or ground based locations may comprise measurements of received signal. The data representative of the coverage of a mobile telecommunications network may comprise one or more numerical values (e.g. when the prediction model is a regression model) and/or one or more classifications such as qualitive labels (e.g. when the prediction mode is a classification model).

The selected subset of data representative of coverage at the subset of ground based locations may comprise at least one of a received signal power, a received signal quality and a timing advance at each of the subset of the ground based locations.

A received signal power may relate to a power of a signal received at a ground based location. The signal may be broadcast or otherwise transmitted over the mobile telecommunications network (e.g. by a base station) and may be received and measured (e.g. by a terminal) at a ground based location. The power of the received signal may be measured to determine a received signal power. The signal may comprise a reference signal transmitted over the mobile telecommunications network (e.g. by a base station). The received signal power may be determined as a Reference Signal Received Power (RSRP). An RSRP may be taken as an average power per resource element that a terminal is receiving on.

A received signal quality may relate to a determined quality of a signal received at a ground based location. The signal may be broadcast or otherwise transmitted over the mobile telecommunications network (e.g. by a base station) and may be received and measured (e.g. by a terminal) at a ground based location. The received signal may be measured to determine a quality of the received signal. The signal may comprise a reference signal transmitted over the mobile telecommunications network (e.g. by a base station). The received signal quality may be determined as a Reference Signal Received Quality (RSRQ). An RSRQ may be taken as a signal-to-interference plus noise ratio of one or more received reference signals.

A timing advance may be indicative of a propagation time for a signal to propagate between a network component (e.g. a base station) and a ground based location. A timing advance may be used in the network to transmit a signal from one communicating party (e.g. a terminal or a base station) in advance of a timeslot allocated to reception of the signal at the other communicating party (e.g. the other of the terminal or the base station).

The selected subset of data representative of coverage at the subset of ground based locations may comprise data representative of network coverage provided by a serving cell at each of the subset of the ground based locations.

A mobile telecommunications network typically operates using a plurality of cells providing network coverage to different geographical areas. The geographical areas over which network coverage is provided by each cell may at least partially overlap. At a given location it may be possible to determine (e.g. by measurement) network coverage provided by each of a plurality of cells. For example, properties such as a received signal power (e.g. RSRP), received signal quality (e.g. RSRQ) and/or a timing advance may be determined (e.g. by measurement) for each of a plurality of cells.

A terminal connecting to or otherwise communicating over the network may establish connection with the network over one or more cells. For example, a terminal may establish a connection over a primary cell and may subsequently establish communication over one or more secondary cells. Each of the cells over which a terminal communicates with the network is considered to be a serving cell. The serving cell(s) includes at least a primary cell and may include one or more secondary cell(s) (e.g. where a terminal is configured for carrier aggregation).

The selected subset of data representative of coverage at the plurality of ground based locations may comprise data representative of network coverage provided by at least a serving cell at that location. In some examples, the selected subset of data representative of coverage at the plurality of ground based locations comprises data representative of network coverage provided by a plurality of serving cells. For example, the selected subset of data representative of coverage at the subset of ground based locations may comprise data representative of network coverage provided by a primary cell and at least one secondary cell.

The selected subset of data representative of coverage at the subset of ground based locations may comprise data representative of network coverage provided by a plurality of cells at each of the subset of the ground based locations.

As was explained above, at a given location it may be possible to determine network coverage provided by each of a plurality of cells. For example, properties such as a received signal power (e.g. RSRP), received signal quality (e.g. RSRQ) and/or a timing advance may be determined (e.g. by measurement) for each of a plurality of cells. Such measurements may be included in the selected subset of data representative of coverage at the plurality of ground based locations. The plurality of cells may include at least one serving cell (which may, for example, include a primary cell and/or at least one secondary cell). The plurality of cells may include neighbouring cells to the at least one serving cell.

The method may further comprise providing at least one further input to the prediction model, wherein the at least one further input is based on the geographical position of the identified location above ground and/or the geographical positions of the selected subset of the ground based locations.

In addition to the property of the identified location above ground and the selected subset of data representative of coverage at ground based locations, the prediction model may be provided with one or more further inputs. The further inputs may, for example, relate to the geographical position of the identified location above ground and/or the geographical positions of the selected subset of the ground based locations. For example, the further inputs may include a measure of the absolute and/or relative geographical positions of the identified location above ground and/or the geographical positions of the selected subset of the ground based locations. Measures of the absolute geographical positions of the identified location above ground and/or the geographical positions of the selected subset of the ground based locations may include one or more of the latitude, longitude and altitude of the relevant location. Measures of the relative geographical positions of the identified location above ground and/or the geographical positions of the selected subset of the ground based locations may include a measure of the distances between the identified location above ground and the selected subset of ground based locations.

The method may further comprise performing feature engineering based on the selected subset of data representative of coverage at ground based locations to determine at least one further input to the prediction model.

Feature engineering may be used to derive one or more further inputs to the prediction model based on the available data. For example, performing feature engineering may comprise deriving one or more features based on a combination of features of the data representative of coverage at ground based locations. For example, one or more features may be derived based on more than one of features such as a received signal power, a received signal quality and a timing advance associated with a given location.

According to a second aspect of the present disclosure there is provided apparatus for determining above ground coverage of a mobile telecommunications network, the apparatus comprising: one or more processors; and memory storing: a prediction model configured through training, to determine coverage of a mobile telecommunications network at locations above ground in dependence on data representative of coverage of the mobile telecommunications network at a plurality of ground based locations; and instructions which, when executed by the one or more processors, cause the apparatus to: receive data representative of coverage of the mobile telecommunications network at a plurality of ground based locations; identify a location above ground for which coverage of the mobile telecommunications network is to be determined; select a subset of the data representative of coverage at ground based locations, wherein the subset comprises data representative of coverage of the mobile telecommunications network at a subset of the ground based locations and wherein selecting the subset comprises selecting the subset of the ground based locations in dependence on their location relative to the identified location above ground; provide a property of the identified location above ground and the selected subset of data representative of coverage at ground based locations as inputs to the prediction model; and implement the prediction model to generate an output in dependence on the provided inputs, wherein the output of the model is representative of the coverage of the mobile telecommunications network at the identified location above ground.

According to a third aspect of the present disclosure there is provided a computer implemented method of training a prediction model for determining above ground coverage of a mobile telecommunications network, the method comprising: receiving data representative of coverage of the mobile telecommunications network at a plurality of ground based locations; receiving data representative of coverage of the mobile telecommunications network at a plurality of locations above ground; for each of the plurality of locations above ground, selecting a subset of the ground based locations in dependence on their location relative to the location above ground; forming a plurality of training data records, each training data record being associated with a location above ground and comprising the received data representative of the coverage of the mobile telecommunications network at the location above ground and a subset of the data representative of coverage of the mobile telecommunications at ground based locations, wherein the subset of the data comprises data representative of coverage of the mobile telecommunications network at the subset of ground based locations selected for the location above ground; and training the prediction model for determining above ground coverage of a mobile telecommunications network using the plurality of training data records.

The plurality of ground based locations may comprise locations which are located substantially at ground level. For example, the plurality of ground based locations may include locations substantially at ground level (e.g. locations at which ground based users may operate a device) and/or locations inside ground based buildings. For example, the plurality of ground based locations may include locations at which a device may be supported by a ground based building. The plurality of ground based locations may include locations which are above the local ground level but are still ground based. For example, the plurality of ground based locations may include one or more locations supported by a ground based building such as a multi-storey ground based building.

The plurality of locations above ground may comprise locations which are not accessible from the ground or a ground based structure, or other object. For example, a location above ground may comprise a location in the air which is accessible via an airborne platform, such as a drone.

The mobile telecommunications network may comprise a cellular network. The network may include a plurality of base stations. Each base station may comprise at least one antenna configured to exchange communications (e.g. radio frequency signals) with terminals situated within a geographical coverage area (e.g. a cell) serviced by the base station over an air interface.

The data representative of coverage of the mobile telecommunications network may comprise data which is indicative of one or more properties of network coverage provided at the relevant location. For example, the data representative of coverage of the mobile telecommunications network may comprise data which is indicative of a signal power and/or quality associated with the network which is received at the relevant location. A signal power and/or quality associated with the network which is received at the relevant location may comprise a power and/or quality of a signal which is transmitted by a network component, such as a base station, and is received at the relevant location.

The data representative of coverage of the mobile telecommunications network may be based on measurements of received signal. For example, the data representative of coverage of the mobile telecommunications network at a plurality of ground based locations may be based on measurements of received signal measured at one or more ground based locations. The data representative of coverage of the mobile telecommunications network at a plurality of locations above ground may be based on measurements of received signal measured at one or more above ground locations. The received signal may be transmitted over the mobile telecommunications network. The received signal may be received at and measured by one or more devices (e.g. terminals) operating in the network. The received signal may be transmitted by a base station forming part of the mobile telecommunications network. In some examples, the received signal may be received by and measured by a base station. In such examples, the received signal may be transmitted by another base station or may be transmitted by another device operating in the network such as a terminal.

Measurements of received signal transmitted over the network depend on propagation of the signal between at least two devices operating in the network. Measurements of received signal therefore capture more information regarding network coverage than, for example, properties such as a transmission power of a signal transmitted from a base station (which does not include any information on how the signal propagates through a network coverage area).

The data representative of coverage of the mobile telecommunications network at a plurality of ground based locations may comprise at least one property which corresponds to at least one property included in the data representative of coverage of the mobile telecommunications network at a plurality of locations above ground. For example, the data representative of coverage of the mobile telecommunications network at a plurality of ground based locations may be based on measurements (e.g. of received signal) made at the plurality of ground based locations. Correspondingly the data representative of coverage of the mobile telecommunications network at a plurality of locations above ground may be based on corresponding measurements (e.g. of received signal) made at the plurality of above ground locations. For example, the data representative of coverage of the mobile telecommunications network at a plurality of ground based locations may comprise one or more properties such as a received signal power, received signal quality and/or a timing advance. Correspondingly the data representative of coverage of the mobile telecommunications network at a plurality of locations above ground may comprise corresponding one or more properties such as a received signal power, received signal quality and/or a timing advance.

The selected subset of ground based locations may comprise one or more of the plurality of ground based locations. That is, in some examples, the subset may comprise a single ground based location. In other examples, the subset may comprise a plurality of ground based locations.

Training the prediction model may comprise performing supervised learning of the prediction model using the training data records. Training the prediction model may comprise executing a machine learning algorithm. Supervised learning of a prediction model may involve training the model to map an input to an output based on training data records. The input to the prediction model comprises data representative of network coverage at a plurality of ground based locations and the output comprises data representative of network coverage at an above ground location.

The prediction model may comprise a regression model. For example, the output of the prediction model may comprise one or more numerical values representative of the coverage of the mobile telecommunications network at the identified location above ground.

The one or more numerical values representative of the coverage of the mobile telecommunications network may, for example, include a measure of a received signal power, a received signal quality and/or a timing advance associated with the mobile telecommunications network.

The prediction model may comprise a classification model. For example, the output of the prediction model may comprise one or more classifications representative of coverage of the mobile telecommunications network at the identified location above ground. That is, the data representative of network coverage at an above ground location which forms part of the training data records may comprise a qualitive label or other form of classification. The one or more classifications may comprise qualitive labels representative of coverage of the mobile telecommunications network at an above ground location. Such classifications may, for example, include labels such as low, medium, high and/or bad, medium, good etc. Such labels may be associated with a specific measure of network coverage such as signal power and/or signal quality or may provide a more general classification of network coverage.

The prediction model may comprise a machine learning model. For example, the prediction model may be trained and/or implemented using any suitable machine learning algorithm. Examples, of such suitable algorithms may, for example, include a K-nearest neighbour algorithm, a linear prediction algorithm, a support vector machine (e.g. a support-vector clustering algorithm), a decision tree algorithm, a random forest algorithm, an adaptive boosting (AdaBoost) algorithm, a gradient boosting algorithm, a voting algorithm and/or a stacking algorithm. In some examples, the prediction model may comprise an artificial neural network.

The data representative of the coverage of a mobile telecommunications network at above ground locations may comprise one or more numerical values (e.g. when the prediction model is a regression model) and/or one or more classifications such as qualitive labels (e.g. when the prediction mode is a classification model).

Selecting the subset of the ground based locations in dependence on their location relative to the location above ground may comprise selecting a subset of N ground based locations which are the N closest of the plurality of ground based locations to the location above ground, wherein N is an integer equal to or greater than 1.

The method may comprise determining a measure of distance between the location above ground and each of the ground based locations. The measure of distance may comprise a direct distance (i.e. the shortest distance) between a ground based location and the location above ground. The measure of distance may comprise a distance between a ground based location and a position on the ground closest to the above ground location. The position on the ground closest to the above ground location may comprise a position on the ground having substantially the same latitude and longitude as the above ground location.

The measure of distance may be determined for each of the ground based locations relative to the location above ground. The subset of ground based locations may be selected as the N ground based locations having the smallest measure of distance to the location above ground. That is, the selected subset of ground based locations may represent the N ground based locations which are closest to the location above ground. N may be any suitable integer equal to or above 1. For example, N may be 1, 2, 3, 4, 5, 6, 7 . . . etc.

Selecting the subset of the ground based locations in dependence on their location relative to the location above ground may comprise selecting all of the ground based locations which are positioned within a distance threshold of the location above ground.

The method may comprise determining a measure of distance between the identified location above ground and each of the ground based locations. The measure of distance may comprise a direct distance (i.e. the shortest distance) between a ground based location and the location above ground. The measure of distance may comprise a distance between a ground based location and a position on the ground closest to the above ground location. The position on the ground closest to the above ground location may comprise a position on the ground having substantially the same latitude and longitude as the identified above ground location.

The measure of distance may be determined for each of the ground based locations relative to the location above ground. The subset of ground based locations may be selected as ground based locations whose measure of distance to the location above ground is less than a distance threshold. The number of ground based locations included in the subset may be different for different locations above ground and may depend on how many ground based locations are situated in relative proximity to the location above ground. For example, the number of ground based locations included in the subset may be one or greater than 1.

The data representative of coverage of the mobile telecommunications network at a plurality of ground based locations may be based on measurements indicative of coverage of the mobile telecommunications made at a plurality of ground based locations. The measurements may comprise measurements of received signal made at a plurality of ground based locations.

The measurements may, for example, be made by terminals operating in the network. For example, the terminals may connect to or otherwise communicate over the mobile telecommunications network whilst situated at ground based locations. As part of the operation of the terminals at the ground based locations, measurements may be made which are indicative of the coverage provided by the mobile telecommunications network. For example, a terminal may measure one or more reference signals transmitted over the network (e.g. by a base station forming part of the network) and received at the terminal. One or more properties indicative of the coverage provided by the mobile telecommunications network may be determined based on such measurements.

The data representative of coverage of the mobile telecommunications network may comprise measurements made at a plurality of ground based locations. The data representative of coverage of the mobile telecommunications network may comprise one or more properties determined in dependence on measurements made at a plurality of ground based locations. The plurality of ground based locations at which the measurements are made may be the same as the ground based locations. Additionally or alternatively, at least some of the plurality of ground based locations at which measurements are made may be different to the ground based locations. For example, measurements made at different ground based locations may be used to determine (e.g. through extrapolation) data representative of network coverage at the ground based locations. The measurements may comprise measurements of received signal at a ground based location.

The data representative of coverage of the mobile telecommunications network at a plurality of locations above ground may be based on measurements indicative of coverage of the mobile telecommunications made at a plurality of locations above ground. The measurements may comprise measurements of received signal at an above ground location.

The measurements may, for example, be made by one or more devices (e.g. terminals) situated on an airborne platform, such as a drone. For example, one or more dedicated flights may be carried out in order to measure properties indicative of coverage of a network at above ground locations. For example, a device situated on an airborne platform may measure one or more reference signals transmitted over the network (e.g. by a base station forming part of the network) and received at the device. One or more properties indicative of the coverage provided by the mobile telecommunications network may be determined based on such measurements.

The data representative of coverage of the mobile telecommunications network may comprise measurements made at a plurality of above ground locations. The data representative of coverage of the mobile telecommunications network may comprise one or more properties determined in dependence on measurements made at a plurality of above ground locations. The plurality of above ground locations at which the measurements are made may be the same as the above ground locations. Additionally or alternatively, at least some of the plurality of above ground locations at which measurements are made may be different to the above ground locations. For example, measurements made at different above ground locations may be used to determine (e.g. through extrapolation) data representative of network coverage at the ground based locations. The measurements may comprise measurements of received signal at an above ground location.

The data representative of coverage of the mobile telecommunications network at a plurality of above ground locations may comprise one or more classifications associated with network coverage such as qualitive labels of the network coverage.

The received data representative of coverage at the plurality of ground based locations and/or the received data representative of coverage at the plurality of locations above ground may comprise at least one of a received signal power, a received signal quality and a timing advance at each of the locations.

A received signal power may relate to a power of a signal received at an above ground or ground based location. The signal may be broadcast or otherwise transmitted over the mobile telecommunications network (e.g. by a base station) and may be received and measured (e.g. by a terminal) at an above ground or ground based location. The power of the received signal may be measured to determine a received signal power. The signal may comprise a reference signal transmitted over the mobile telecommunications network (e.g. by a base station). The received signal power may be determined as a Reference Signal Received Power (RSRP). An RSRP may be taken as an average power per resource element that a terminal is receiving on.

A received signal quality may relate to a determined quality of a signal received at an above ground or ground based location. The signal may be broadcast or otherwise transmitted over the mobile telecommunications network (e.g. by a base station) and may be received and measured (e.g. by a terminal) at an above ground or ground based location. The received signal may be measured to determine a quality of the received signal. The signal may comprise a reference signal transmitted over the mobile telecommunications network (e.g. by a base station). The received signal quality may be determined as a Reference Signal Received Quality (RSRQ). An RSRQ may be taken as a signal-to-interference plus noise ratio of one or more received reference signals.

A timing advance may be indicative of a propagation time for a signal to propagate between a network component (e.g. a base station) and an above ground or ground based location. A timing advance may be used in the network to transmit a signal from one communicating party (e.g. a terminal or a base station) in advance of a timeslot allocated to reception of the signal at the other communicating party (e.g. the other of the terminal or the base station).

The data representative of coverage of the mobile telecommunications network at a plurality of above ground locations may comprise one or more classifications (such as qualitive labels) derived from at least one of a received signal power, a received signal quality and a timing advance at each of the locations.

The received data representative of coverage at the plurality of ground based locations and/or the received data representative of coverage at the plurality of locations above ground may comprise data representative of network coverage provided by a serving cell at each of the locations.

A mobile telecommunications network typically operates using a plurality of cells providing network coverage to different geographical areas. The geographical areas over which network coverage is provided by each cell may at least partially overlap. At a given location it may be possible to determine network coverage provided by each of a plurality of cells (e.g. by measurement). For example, properties such as a received signal power (e.g. RSRP), received signal quality (e.g. RSRQ) and/or a timing advance may be determined (e.g. by measurement) for each of a plurality of cells.

A terminal connecting to or otherwise communicating over the network may establish connection with the network over one or more cells. For example, a terminal may establish a connection over a primary cell and may subsequently establish communication over one or more secondary cells. Each of the cells over which a terminal communicates with the network is considered to be a serving cell. The serving cell(s) includes at least a primary cell and may include one or more secondary cell(s) (e.g. where a terminal is configured for carrier aggregation).

The data representative of coverage at the plurality of ground based and/or above ground locations comprises data representative of network coverage provided by at least a serving cell at that location. In some examples, the data representative of coverage at the plurality of ground based and/or above ground locations comprises data representative of network coverage provided by a plurality of serving cells. For example, the data may comprise data representative of network coverage provided by a primary cell and at least one secondary cell.

The received data representative of coverage at the plurality of ground based locations and/or the received data representative of coverage at the plurality of locations above ground may comprise data representative of network coverage provided by a plurality of cells at each of the locations.

As was explained above, at a given location it may be possible to determine (e.g. by measurement) network coverage provided by each of a plurality of cells. For example, properties such as a received signal power (e.g. RSRP), received signal quality (e.g. RSRQ) and/or a timing advance may be determined (e.g. by measurement) for each of a plurality of cells. Such measurements may be included in the data representative of coverage at the plurality of ground based and/or above ground locations. The plurality of cells may include at least one serving cell (which may, for example, include a primary cell and/or at least one secondary cell). The plurality of cells may include neighbouring cells to the at least one serving cell.

At least one training record of the plurality of training records may further comprise at least one property based on the geographical position of the location above ground and/or the geographical positions of the selected subset of the ground based locations.

In addition to the data representative of coverage of the network at the location above ground the selected subset of data representative of coverage at ground based locations, the training records may include one or more further data fields. The further data fields may, for example, relate to the geographical position of the location above ground and/or the geographical positions of the selected subset of the ground based locations. For example, the further data fields may include a measure of the absolute and/or relative geographical positions of the location above ground and/or the geographical positions of the selected subset of the ground based locations. Measures of the absolute geographical positions of the location above ground and/or the geographical positions of the selected subset of the ground based locations may include one or more of the latitude, longitude and altitude of the relevant location. Measures of the relative geographical positions of the location above ground and/or the geographical positions of the selected subset of the ground based locations may include a measure of the distances between the location above ground and the selected subset of ground based locations.

The method may further comprise performing feature engineering based on the selected subset of data representative of coverage at ground based locations to determine at least one further field of a training data record.

Feature engineering may be used to derive one or more further data fields included in a training data record based on the available data. For example, performing feature engineering may comprise deriving one or more features based on a combination of features of the data representative of coverage at ground based locations. For example, one or more features may be derived based on more than one of features such as a received signal power, a received signal quality and a timing advance associated with a given location.

According to a fourth aspect of the present disclosure there is provided apparatus for training a prediction model for determining above ground coverage of a mobile telecommunications network, the apparatus comprising: one or more processors; and memory storing instructions which, when executed by the one or more processors, cause the apparatus to: receive data representative of coverage of the mobile telecommunications network at a plurality of ground based locations; receive data representative of coverage of the mobile telecommunications network at a plurality of locations above ground; for each of the plurality of locations above ground, select a subset of the ground based locations in dependence on their location relative to the location above ground; form a plurality of training data records, each training data record being associated with a location above ground and comprising the received data representative of the coverage of the mobile telecommunications network at the location above ground and a subset of the data representative of coverage of the mobile telecommunications at ground based locations, wherein the subset of the data comprises data representative of coverage of the mobile telecommunications network at the subset of ground based locations selected for the location above ground; and training the prediction model for determining above ground coverage of a mobile telecommunications network using the plurality of training data records.

According to a fifth aspect of the present disclosure there is provided a computer program comprising instructions which, when executed, cause a method according to the first aspect or a method according to the third aspect to be implemented.

The computer program may be stored on a computer readable medium. The computer readable medium may comprise a non-transitory computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF FIGURES

One or more embodiments of the invention are shown schematically, by way of example only, in the accompanying drawings, in which:

FIG. 1 is a schematic illustration of an environment in which a mobile telecommunications network may operate;

FIG. 2 is a flow chart of an example method for training a model for determining above ground coverage of a mobile telecommunications network;

FIGS. 3A and 3B are schematic representations of locations which may be used in an example of the method of FIG. 2;

FIG. 4 is a flow chart of an example method for determining above ground coverage of a mobile telecommunications network using a trained prediction model;

FIGS. 5A and 5B are representations of the results of a determination of network coverage at above ground locations; and

FIG. 6 is a schematic illustration of an example electronic device which may be used to implement all or part of any method described herein.

### DETAILED DESCRIPTION

Before particular examples of the present invention are described, it is to be understood that the present disclosure is not limited to the particular examples described herein. It is also to be understood that the terminology used herein is used for describing particular examples only and is not intended to limit the scope of the claims.

In describing and claiming the apparatus and methods of the present invention, the following terminology will be used: the singular forms “a”, “an”, and “the” include plural forms unless the context clearly dictates otherwise. Thus, for example, reference to “a terminal” includes reference to one or more of such elements.

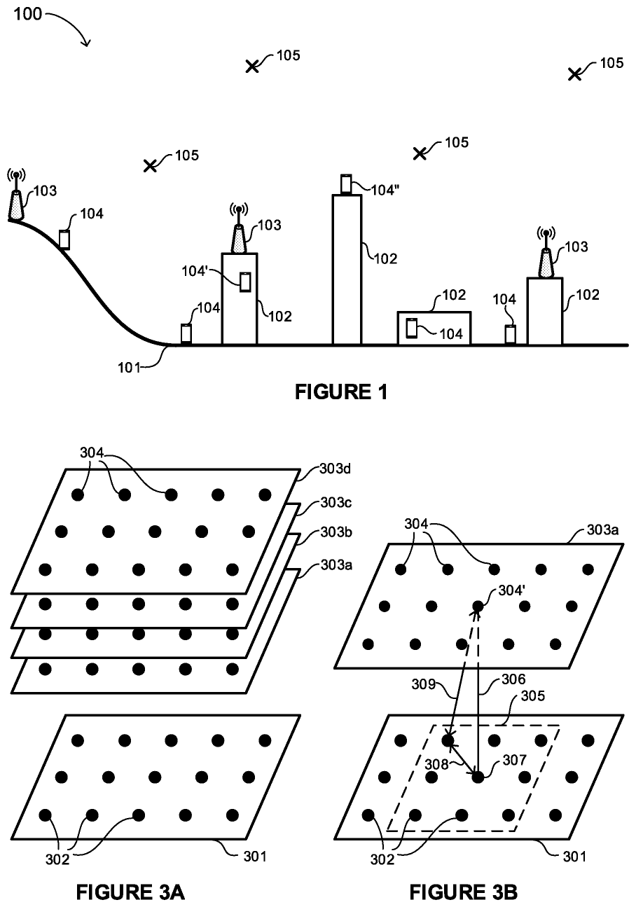

FIG. 1 is a schematic illustration of an environment 100 in which a telecommunications network may operate. The depiction shown in FIG. 1 includes a depiction of a ground level 101 which represents the surface of the land in the environment 100 but could equally be taken as a surface of a body of water (such as a river, lake, the sea etc.) In general, references herein to a ground level may be taken to be a surface level of land and/or water. As can be seen in FIG. 1, the ground level 101 varies as a function of position in the depicted environment 100. In particular a region of increased elevation (relative to the ground level of the rest of the environment 100) is shown on the left-hand side of the environment 100 depicted in FIG. 1. That is, the ground level on the left-hand side of the environment 100 of FIG. 1 is situated at a greater elevation above sea level than the ground level on the right-hand side of the environment 100 depicted in FIG. 1.

Also shown in FIG. 1 are a plurality of buildings 102 situated in the environment 102. The buildings 102 are all ground based, in that they extend by a building height substantially from the ground level 101.

Also shown in FIG. 1 are a plurality of base stations 103 forming part of a mobile telecommunications network operating in the environment 100. The base stations 103 are configured to transmit and receive communication signals over an air interface. For example, each base station 103 may comprise at least one antenna configured to exchange communications (e.g. radio frequency signals) with terminals 104 situated within a geographical coverage area (e.g. a cell) serviced by the base station 103 over an air interface 121. Each base station 103 may exchange communications by transmitting and/or receiving communications in one or more frequency bands assigned to a Radio Access Technology (RAT) used by the base station 103 and utilising communication protocols specified for the RAT (e.g. standardised communication protocols for the RAT). Suitable RATs may include, for example, the Global System for Mobile Communications (GSM), the Universal Mobile Telecommunications System (UMTS), Long Term Evolution (LTE) and/or 5G New Radio (NR). The base stations 103 may take any suitable form and may, for example, comprise a GMS and/or UMTS compatible base station such as a Node B, an Evolved NodeB (eNB) and/or a 5G NR gNodeB. The base stations 103 typically have a backhaul connection with one or more core networks (not shown) with which users of the telecommunications network are registered.

Each base station 103 may have at least one geographical coverage area over which it can reliably communicate with terminals 104 situated within the geographical coverage area. Such a geographical coverage area may be referred to as a cell. In at least some examples, a single base station 103 may transmit and receive in a plurality of cells. For example, a base station 103 may simultaneously operate a plurality of antennas which serve different geographical coverage areas. Such a base station 103 may be considered to operate a plurality of different cells.

A cell associated with a base station 103 may be geographically separate from a cell associated with other neighbouring base stations and/or another cell operated by the same base station 103. Alternatively there may be some geographic overlap between different cells operated by the same or different base stations 103. A given terminal 104 may be situated within the geographic coverage of a single cell, multiple cells or may be situated in an area where no network coverage is provided (i.e. the terminal is not situated within the coverage area of any cell).

The terminals 104 may be any suitable electronic device capable of connecting to or otherwise communicating with the mobile telecommunications network. Suitable examples of a terminal 104 as referred to herein may include User Equipment devices (UEs) such as mobile telephones, tablets, personal computers etc. and/or other forms of terminal device which may not be directly used by a user. For example, terminals 104 which connect to and communicate over the mobile telecommunications network may or may not include a user interface which allows for direct user interaction with the terminal 104.

As shown in FIG. 1, terminals 104 may be situated in a number of different locations within the environment 100. For example, some of the terminals 104 shown in FIG. 1 are situated substantially at the ground level 101. Such terminals 104 may be situated outside and substantially at the ground level 101 and/or may be situated inside buildings (e.g. on a ground floor of a building 102). It will be appreciated that not all of the terminals 104 situated substantially at ground level 101 may be situated at the same height or altitude relative to some reference height (e.g. height above sea level). For example, one of the terminals 104 shown in FIG. 1 is situated in the region of increased elevation shown on the left-hand side of the environment 100. This terminal 104 is situated substantially at the local ground level but due to the increased elevation of the ground level 101 in this region, the terminal 104 is situated at a greater height (e.g. height above sea level) than at least some of the other terminals 104 shown in FIG. 1.

Also shown in FIG. 1 are terminals 104 which are situated above the ground level 101. For example, the terminal marked 104′ in FIG. 1 may be situated inside a multi-storey building 102 and above the ground floor of the building 102. The terminal marked 104″ in FIG. 1 may be situated outside but supported by a building 102. For example, terminal 104″ may be situated on the roof or balcony of the building 104″ or may be otherwise supported by the building 102 at a height above the ground level 101.

In the environment 100 shown in FIG. 1, all of the terminals labelled 104 (including the terminals 104′, 104″) are situated at ground based locations. As was explained above, such ground based terminals 104 may include terminals which are situated at different heights relative to a common reference such as sea level. For example, the terminal 104 situated in the region of increased elevation is situated at a greater height above sea level than other terminals 104 situated at ground level in other regions of the environment 100. Furthermore, the terminals 104′, 104″ which are supported by buildings 102 above the local ground level 101 are situated at a greater height above sea level than nearby terminals 104 situated at ground level 101. For the purposes of this disclosure, the term ground based locations is considered to encompass all locations which are supported by the ground. Ground based locations may include locations inside or outside of buildings or other artificial structures and may include locations inside or outside of ground based modes of transport such as ground based vehicles. Terminals situated at ground based locations may include terminals which are supported by users which are themselves supported by the ground and/or ground based structures or objects. In general, ground based locations may be considered to be all locations at which a terminal may be positioned without being airborne.

Typically, the vast majority of terminals 104 which connect to and communicate over a mobile telecommunications network are situated at ground based locations. A terminal 104 capable of connecting to and communicating over the mobile telecommunications network is typically capable of making one or more measurements indicative of the coverage provided by the mobile telecommunications network at the location at which the terminal is situated at the time of making the one or more measurements. For example, a terminal 104 may be configured to measure one or more properties indicative of network coverage as part of the routine operation of the terminal 104. The measurements may comprise measurements of signal received at the terminal 104.

In at least some examples, a base station 103 may routinely transmit a reference signal for the purpose of measurement of the reference signal by a terminal 104. A terminal may make measurements of the reference signal and may for example, determine one or more variables indicative of measurement of the reference signal (received by the terminal 104). For example, a terminal may determine a measure of the power of one or more reference signals received at the terminal 104. A typical example of such a measure is the reference signal received power (RSRP), which may, for example, be determined by terminals operating according to LTE protocols. More specifically, the RSRP may be taken as an average power per resource element that a terminal is receiving on. Additionally or alternatively, a terminal 104 may determine a measure of the quality of one or more reference signals received at the terminal 104. A typical example of such a measure is the reference signal received quality (RSRQ), which may, for example, be determined by terminals operating according to LTE protocols. More specifically, the RSRQ may be taken as a signal-to-interference plus noise ratio of one or more received reference signals.

Measurements such as a received signal power (e.g. RSRP) and/or received signal quality (e.g. RSRQ) may be utilised by a terminal 104 for a number of different purposes such as cell selection. For example, a terminal 104 may receive reference signals transmitted over a plurality of different cells. The terminal may measure received reference signals and determine one or more properties such as received signal power (e.g. RSRP) and/or received signal quality (e.g. RSRQ) of reference signals of a plurality of different cells. Such properties may be used, during routine operation of a terminal, to select a cell over which to communicate with the network. For example, a cell having a RSRP and/or RSRQ exceeding given thresholds may be selected by a terminal as the terminal's primary or serving cell.

A received signal power (e.g. RSRP) and/or a received signal quality (RSRQ) determined for a terminal 104 may be associated with a particular base station 103 and/or cell. In some examples, for a given terminal 104 a plurality of different received signal powers and/or received signal qualities may be determined. Each determined received signal power and/or received signal quality may be associated with a different cell. For example, a terminal 104 may determine a first received signal power and/or a first received signal quality based on a reference signal transmitted over a first cell and may determine a second received signal power and/or a second received signal quality based on a reference signal transmitted over a second cell. The first cell and the second cell may be operated by the same or different base stations 103.

Properties such as received signal power (e.g. RSRP) and/or received signal quality (e.g. RSRQ) are examples of properties representative of the coverage of a mobile telecommunications network. In addition to, or as an alternative to, a received signal power and/or a received signal quality, one or more other properties representative of the coverage a mobile telecommunications network may be determined (e.g. by measurement). For example, a base station 103 and/or a terminal 104 may determine a propagation time associated with signals exchanged between the base station 103 and/or the terminal 104. Such a propagation time is generally at least a function of the distance between the terminal 104 and the base station 103. A typical measure of a propagation time between a base station 103 and a terminal 104 is a timing advance. A timing advance associated with a base station 103 and a terminal 104 may be determined and used to transmit a signal from one communicating party (e.g. a terminal 104 or a base station 103) in advance of a timeslot allocated to reception of the signal at the other communicating party (e.g. the other of the terminal 104 or the base station 103). Similarly to the received signal power and/or received signal quality, a timing advance associated with a terminal 104 may be a measure which is routinely determined during operation of a terminal 104 in a mobile telecommunications network. A timing advance determined for a terminal 104 may be associated with a particular base station 103 and/or cell. In some examples, for a given terminal 104 a plurality of different timing advances, each associated with a different base station 103 and/or cell, may be determined.

As was described above, a terminal 104 and/or a base station 103 operating in a mobile telecommunications network may measure or otherwise determine one or more properties (such as received signal power, received signal quality and/or timing advance) associated with the coverage provided by the network. The determined properties may be based on measurement of received signal. Such determined properties may be associated with a geographic location at which the terminal 104 is situated. Determined properties associated with the network coverage at one or more locations may be reported to the network, for example, to a base station 103 and/or a core network.

Properties associated with network coverage determined at a plurality of different locations may be collated to provide data representative of coverage of a mobile telecommunications network at a plurality of different locations. As was explained above, typically the vast majority of terminals 104 connecting to a mobile telecommunications network are situated at ground based locations (e.g. the locations at which terminals 104 are situated in FIG. 1). Consequently data representative of coverage of a mobile telecommunications network may be relatively abundant at ground based locations. The relative abundance of data representative of network coverage at ground based locations, may allow for a relatively accurate, and high resolution determination to be made as to the network coverage provided at different ground based locations. Such a determination may be updated over time (e.g. periodically) based on new measurements made by terminals 104. This may, for example, allow a network operator to monitor network coverage at ground based locations.

As was explained above, increasingly terminal devices connected to and/or communicating over a mobile telecommunications network may be situated at non-ground based locations. For example, a terminal may be situated on an airborne platform such as a drone which may be flown above ground (i.e. at altitude). The location of a number of example airborne terminals 105 are depicted in FIG. 1 by crosses labelled 105. The above ground locations at which the airborne terminals 105 are situated differ from the ground based locations at which the ground based terminals 104 are situated, in that the above ground locations are not supported by the ground or any ground based structure. Consequently an airborne platform such as a drone is required in order to locate a terminal 105 at the above ground locations.

Generally, the term above ground location is used herein to refer to locations which are only accessible by airborne platforms. That is, an above ground location is intended to refer to a location which is at some altitude above the local ground level 101 and is not accessible via a ground based structure such as a building 102.

A network connected drone or other airborne platform may include a terminal device 105 capable of connecting to and communicating over a mobile telecommunications network in the same way as a terminal 104 situated at a ground based location. Such terminals 105 may measure and determine properties associated with the coverage provided by the network in an analogous way to ground based terminals 104. For instance such terminals 105 may measure signal received at the terminals 105 (which may have been transmitted by a base station). For example, properties such as a received signal power (e.g. RSRP), a received signal quality (e.g. RSRQ), and/or a timing advance may be measured or otherwise determined by above ground terminals 105 in the same way as ground based terminals 104.

However, typically there are far fewer terminals 105 operating in a network and situated in above ground locations than there are terminals 104 situated in ground based locations. Consequently, there may be significantly less measured data available which is representative of network coverage at above ground locations than ground based locations. It may therefore be very difficult or impossible to build up an accurate and sufficiently high resolution representation of network coverage at above ground locations from data measured at above ground locations.

Furthermore, at a given latitude and longitude there may only be limited number of ground based locations for which network coverage may be determined. For example, for a given latitude and longitude the ground based network coverage may simply be measured or otherwise determined substantially at the local ground level at that latitude and longitude. However, for a given latitude and longitude there may be a plurality of different above ground locations corresponding to different altitudes at which it may be desirable to determine network coverage. Furthermore, the network coverage may significantly vary as a function of altitude at a given latitude and longitude. In order to build up a representation of network coverage at above ground locations (based on measurements made at above ground locations) it may be necessary to obtain measurements taken at different altitudes as well as at different latitudes and longitudes.

One way in which the availability of network coverage data at above ground locations may be improved is to fly dedicated flights of airborne devices (e.g. a drone including a terminal device 105) in order to obtain measurements at a plurality of different above ground locations. Such flights have been carried out and have been used to accurately determine above ground network coverage in the geographic regions in which the flights have been carried out. However the determination of above ground network coverage using this method is limited to the locations at which airborne terminals have been flown. Consequently, obtaining data across the entire coverage area of a network using this method may require a very large number of dedicated flights to be conducted. Such flights are typically expensive and time consuming and in some areas impractical.

As an alternative to directly measuring properties associated with network coverage at above ground locations, it has been realised that data representative of network coverage at ground based locations may be used to accurately determine network coverage at corresponding above ground locations. As was explained above, measurements (e.g. of received signal) may be made at ground based locations during the normal operation of ground based terminals 104 in the network. Consequently, measurements at ground based locations may be available across a wide geographical range. The use of measurements made at ground based locations to determine network coverage at above ground locations may therefore allow network coverage to be determined at above ground locations at which no measurements have previously been made.

It has been realised that an effective way of determining network coverage at a wide range of above ground locations based on ground based measurements (e.g. of received signal), is to utilise ground based measurements and above ground measurements taken in the same vicinity. For example, ground based and above ground measurements taken in the same vicinity may be used to establish a relationship between network coverage at ground based locations and network coverage at above ground locations in the vicinity of the ground based locations. Such a relationship may be captured by training a model for determining network coverage at above ground locations based on network coverage at ground based locations. Such a model may be trained using measurements made at ground based locations (e.g. of received signal) and above ground locations (e.g. of received signal) in a region in which above ground measurements are available. The trained model can then be used to determine network coverage at above ground locations for which little or no above ground measurements are available, based on ground based measurements in the vicinity of the above ground locations.

It will be appreciated, for example from the example environment shown in FIG. 1 that a number of different factors may influence the properties of network coverage at different locations. For example, factors such as a distance from a nearest base station 103, as well as properties of the base station 103, will influence factors such as a received signal strength, received signal quality and timing advance at a given location. Furthermore, features of the local environment may influence properties of network coverage. For example, artificial structures such as buildings may serve to obstruct or distort radio signals propagating over the network. This may in particular be the case for radio signals transmitted using relatively high frequencies, such as those used in 5G NR implementations. Additionally or alternatively, natural obstructions such as regions of increased elevation and/or vegetation may also serve to obstruct or distort radio signals and will therefore influence the network coverage at different locations.

The various influences on the coverage provided by the network at different locations (such as one or more of the effects described above) may be difficult to capture, monitor and model. As such, an accurate prediction of network coverage at above ground locations may be difficult to achieve. For example, any attempt to model above ground network coverage using knowledge of network components (e.g. base stations) and, for example, modelling the propagation of signals transmitted from the network components may be complicated and relatively inaccurate. For instance, such a modelling approach may fail to capture the effect of features of the local environment such as obstructions without a very detailed knowledge and modelling of the specific environment. For example, even if the power of a signal transmitted from a base station is known, this does not provide information about how the transmitted signal propagates through the surrounding environment.

Despite the complications explained above, it has been found that much of the information needed to determine network coverage at above ground locations is captured in measurements of network coverage made at ground based locations, such as measurements made during routine operation of network connected devices. In particular, measurements made of received signal at ground based locations depends on how signals propagate through the network environment and may capture information needed to determine network coverage at above ground locations. For example, the effects of a local environment (such as natural or artificial obstructions) which will impact above ground coverage will also influence the measurements made at ground based locations and thus such effects are captured in the ground based measurements (e.g. of received signal). The ground based measurements may therefore be used to provide an accurate determination of above ground coverage. Nevertheless, the mapping of ground based coverage to above ground coverage may not be simple. However, it has been found that through the training and implementation of a prediction model as described herein an accurate determination of above ground network coverage can be obtained based on measurements made at ground based locations (e.g. of received signal).

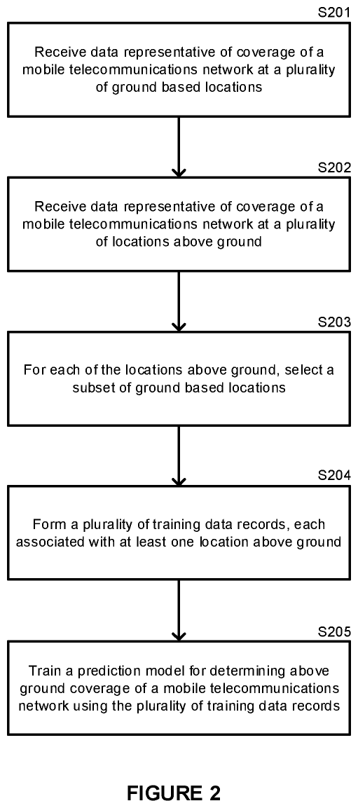

FIG. 2 is a flow chart of an example method for training a model for determining above ground coverage of a mobile telecommunications network. The method may be implemented on any suitable computing device. In some examples, each method step may be implemented on the same computing device. In other examples, different parts of the method may be implemented on different computing devices which may be in communication with each other. FIGS. 3A and 3B are schematic representations of locations which may be used in an example of the method of FIG. 2.

At step 201 of FIG. 2, data representative of coverage of a mobile telecommunications network at a plurality of ground based locations is received. As was explained above with reference to FIG. 1, data representative of coverage of a mobile telecommunications network may be measured or otherwise determined by terminals 104 operating in the network at ground based locations. For examples, terminals 104 situated at ground based locations may measure signal received by the terminals 104. Terminals 104 situated at ground based locations may determine one or more properties such as a received signal power (e.g. RSRP), a received signal quality (e.g. RSRQ) and/or a timing advance. As was explained above, the one or more determined properties may be associated with a particular cell and/or base station. In some example, one or more of the determined properties (e.g. a received signal power, a received signal quality and/or a timing advance) may be determined for a plurality of different cells or base stations. The determined properties may be associated with an identifier of the cell or base station with which it is associated. For example, a determined property (e.g. a received signal power, a received signal quality and/or a timing advance) may be associated with a Physical Cell Identifier (PCI) of the cell with which the property is associated.

A terminal 104 operating in the network may select a cell with which its main connection to network is established. Such a cell may be considered to be the terminal's serving cell. In some examples, a terminal 104 may have a plurality of serving cells. For example, where a terminal 104 is configured for carrier aggregation, a terminal's serving cells may include a primary cell and/or one or more secondary cells. In some examples, a terminal 104 may measure or otherwise determine one or more properties such as a received signal power (e.g. RSRP), a received signal quality (e.g. RSRQ) and/or a timing advance for each of its serving cells (which may be a single serving cell or a plurality of serving cells). Additionally or alternatively a terminal 104 may measure or otherwise determine one or more properties such as a received signal power (e.g. RSRP), a received signal quality (e.g. RSRQ) and/or a timing advance for other neighbouring cells which are not a serving cell of the terminal 104.

The data representative of coverage of a mobile telecommunications network at a plurality of ground based locations may, for at least some of the ground based locations, include data representative of network coverage provided by a plurality of cells. For example, for at least some ground based locations, the data may include one or more properties indicative of network coverage provided by a serving or primary cell. For at least some ground based locations the data may include one or more properties indicative of network coverage provided by one or more additional cells, which may be neighbouring cells (e.g. to a serving or primary cell).

The one or more properties indicative of network coverage at a plurality of different ground based locations may be determined (e.g. by measurement of received signal) by different terminals 104 situated at different ground based locations. In some examples, a given terminal 104 may move between different ground based locations and may determine one or more properties indicative of network coverage at a plurality of different locations.

In the representation shown in FIG. 3A, a plurality of ground based locations 302 are shown, each situated substantially at a ground level 301. Each of the ground based locations 302 may represent locations at which data is available which is representative of network coverage at that location. For example, properties such as a received signal power (e.g. RSRP), a received signal quality (e.g. RSRQ) and/or a timing advance associated with one or more base stations 103 may have been determined (e.g. by measurement) for each of the ground based locations 302 shown in FIG. 3A.

For ease of illustration, in the representation of FIG. 3A, the ground level 301 is represented by a plane. However, as was described above, the height (e.g. height above sea level) may vary as a function of position). Furthermore, each of the ground based positions 302 are shown as being situated at ground level 301. However, as was described above, ground based locations 302 may include at least some locations which are not situated exactly at ground level 301. For example, locations inside of ground based buildings (e.g. above ground floor level) are also considered to be ground based locations 302.

In the representation of FIG. 3A, the ground based locations 302 are shown to be situated on a substantially uniform grid. For example, in the representation of FIG. 3A, the distance separation is approximately the same between each ground based location 302 and its surrounding ground based locations 302. Whilst such a uniform arrangement has been shown in FIG. 3A, in at least some examples, ground based locations 302 at which one or more properties indicative of network coverage have been determined may be distributed in a non-uniform arrangement. For example, ground based locations 302 at which one or more properties indicative of network coverage have been determined may correspond to locations at which terminals 104 have been located during normal operation (and have made measurements of received signal). Such locations may not necessarily conform to a uniform arrangement. In some examples, measurements made by terminals 104 distributed at ground based locations which do not conform to a uniform arrangement may be extrapolated onto locations arranged in a uniform manner. For example, measurements made at distributed ground based locations at which terminals 104 are situated during normal operation may be extrapolated to determine corresponding properties at ground based locations 302 which may be different to the locations at which the measurements were made. For example, measurements may be extrapolated onto a uniform arrangement of ground based locations 302 such as those shown schematically in FIG. 3A. Such extrapolated properties are still based on measurements (e.g. of received signal) made at ground based locations.

The ground based locations 302 may be distributed with any suitable density and separation. In some examples, the separation between neighbouring ground based locations may be of the order to tens of metres. For example, the separation between neighbouring ground based locations may be greater than about 10 metres. The separation between neighbouring ground based locations may be less than about 100 metres.

The data representative of coverage of a mobile telecommunications network which is received at step 201 may comprise measurements (e.g. of received signal) made by one or more terminals 104. Additionally or alternatively the data may comprise properties which are determined in dependence on measurements made by one or more terminals. Receiving the data in step 201 may take any suitable form. For example, receiving the data may comprise reading the data from memory and/or receiving the data from another device at which the data is stored.

At step 202 in FIG. 2, data representative of coverage of a mobile telecommunications network at a plurality of locations above ground is received. As was explained above with reference to FIG. 1, data representative of coverage of a mobile telecommunications network may be measured or otherwise determined by one or more devices (e.g. terminals 104) located on an airborne platform (e.g. based on measurements of received signal). For example, one or more devices may be situated on a drone or other airborne platform and may be flown to different above ground locations in order to measure one or more properties indicative of network coverage at the different above ground locations. The one or more properties determined at different above ground locations may include the same or different properties to those determined at ground based locations 302. For example, the one or more properties determined at different above ground locations may include a received signal power (e.g. RSRP), a received signal quality (e.g. RSRQ) and/or a timing advance associated with one or more base stations 103.

As was explained above with reference to properties determined for ground based locations 302, one or more determined properties determined at above ground locations may be associated with a particular cell and/or base station. In some example, one or more of the determined properties (e.g. a received signal power, a received signal quality and/or a timing advance) may be determined for a plurality of different cells or base stations. The determined properties may be associated with an identifier of the cell or base station with which it is associated. For example, a determined property (e.g. a received signal power, a received signal quality and/or a timing advance) may be associated with a Physical Cell Identifier (PCI) of the cell with which the property is associated.

The data representative of coverage of a mobile telecommunications network at a plurality of above ground locations may, for at least some of the above ground locations, include data representative of network coverage provided by a plurality of cells. For example, for at least some above ground locations, the data may include one or more properties indicative of network coverage provided by a serving or primary cell. For at least above ground locations the data may include one or more properties indicative of network coverage provided by one or more additional cells, which may be neighbouring cells (e.g. to a serving or primary cell).

In the representation shown in FIG. 3A, a plurality of above ground locations 304 are shown, each situated at an altitude above the ground level 301. The above ground locations 304 may include locations situated at a plurality of different altitudes 303a-303d above the ground level 301. For example, in the schematic depiction of FIG. 3A locations 304 are shown as being situated on four different altitude levels 303a-303d represented as planes in FIG. 3A.

Each of the above ground locations 304 shown in FIG. 3A may represent locations at which data is available which is representative of network coverage at that location. For example, properties such as a received signal power (e.g. RSRP), a received signal quality (e.g. RSRQ) and/or a timing advance associated with one or more base stations 103 may have been determined for each of the above ground locations 304 shown in FIG. 3A.

Similarly to the ground based locations 302, the above ground locations 304 may be substantially uniformly arranged or may be arranged in a non-uniform arrangement. In the representation of FIG. 3A, the above ground locations 304 are shown to be situated on a substantially uniform grid. For example, in the representation of FIG. 3A, the distance separation is approximately the same between each above ground location 304 and its surrounding above ground locations 304. Whilst such a uniform arrangement has been shown in FIG. 3A, in at least some examples, the above ground locations 304 at which one or more properties indicative of network coverage have been determined may be distributed in a non-uniform arrangement. Similarly to the ground based locations 302, the above ground locations may comprise locations at which measurements of properties indicative of network coverage have been measured and/or may comprise locations onto which measured properties are extrapolated to. Generally, for above ground locations 304 there may be greater flexibility as to the locations at which the properties are measured since such measurements are typically made during dedicated flights of an airborne platform (e.g. a drone) which may be directed to specific locations in order to make measurements at desired locations. Such extrapolated properties are still based on measurements (e.g. of received signal) made at above ground locations.

The above ground locations 304 may be distributed with any suitable density and separation. In some examples, the separation between neighbouring above ground locations may be of the order of tens of metres. For example, the separation between neighbouring above ground locations may be greater than about 10 metres. The separation between neighbouring above ground locations may be less than about 100 metres.

The data representative of coverage of a mobile telecommunications network which is received at step 202 may comprise measurements (e.g. of received signal) made by one or more terminals 104 situated on an airborne platform. Additionally or alternatively the data may comprise properties which are determined in dependence on measurements (e.g. of received signal) made by one or more terminals situated on an airborne platform. Receiving the data in step 202 may take any suitable form. For example, receiving the data may comprise reading the data from memory and/or receiving the data from another device at which the data is stored.

The data representative of coverage of a mobile telecommunications network which is received at step 202 may comprise numerical values, for example, belonging to a continuous range of values. For examples, properties such as a received signal power, received signal quality and/or timing advance may be quantified in the form of one or more numerical values. In some examples, the data representative of coverage of a mobile telecommunications network which is received at step 202 may comprise one or more classifications associated with the network coverage. For example, one or more qualitive labels may be designated to represent the network coverage. Suitable qualitive labels may, for example, include labels such as “low”, “medium”, “high” and/or “bad”, “medium”, “good” etc. Such labels may be associated with a specific measure of network coverage such as signal power and/or signal quality or may provide a more general classification of network coverage. Such labels may be determined, for example, based on measurements of one or more properties indicative of network coverage.

As is shown in FIG. 3A, the ground based locations 302 for which data is received in step 201 and the above ground locations 304 for which data is received in step 202 correspond to substantially the same geographic area. For example, the ground based locations 302 and the above ground locations 304 may cover a region of approximately the same latitude and longitudes. That is, the above ground locations 304 may be situated substantially above the ground based locations 302. It will be appreciated that the precise latitude and longitude of each above ground location 304 may not correspond directly with the latitude and longitude of a corresponding ground based location 302. However, generally the range of latitudes and longitudes covered by the ground based locations 302 received at step 201 will at least overlap the range of latitudes and longitudes covered by the above ground locations 304 received at step 202. Since data is generally more abundantly available at ground based locations 302, the ground based locations may cover a wider geographic area than the above ground locations. For example, the range of latitudes and longitudes covered by the ground based locations 302 may be greater than the range of latitudes and longitudes covered by the above ground locations 304.

At step 203 of FIG. 2, for each of the above ground locations 304 a subset of the ground based locations 302 may be selected. The subset of ground based locations 302 which are selected for a given above ground location 304 may comprise locations at which the network coverage is determinative of the network coverage at the given above ground location 304. For example, the selected subset of ground based locations 302 may correspond to locations which are near to and in the same vicinity as the given above ground location 304.

FIG. 3B shows a given above ground location 304′ for which a subset of the ground based locations 302 is to be selected. The above ground location 304′ is situated at the altitude labelled 303a in FIG. 3B but could equally be taken to be any above ground location 304 situated at any altitude. For a given above ground location 304′ a number of different methods may be used to select a subset of ground based locations 302. In at least some examples, the closest position on the ground 301 to the above ground location 304′ may be identified as illustrated by the line 306 shown in FIG. 3B. For example, a position 307 on the ground having substantially the same latitude and longitude as the above ground location 304′ may be identified. The position 307 may substantially correspond to a ground based location 302 at which network coverage data is available or may be positioned between ground based locations 302 at which network coverage data is available.

In at least some examples, a subset of ground based locations 302 may be selected as the N ground based locations 302 which are closest to the position 307 on the ground closest to the above ground location 304′, where N is an integer equal to or greater than one. For example, a distance between each ground based location 302 and the position 307 on the ground closest to the above ground location 304′ may be calculated. One such distance 308 between a ground based location 302 and the position 307 on the ground closest to above ground location 304′ is labelled 308 in FIG. 3B. The N ground based locations 302 having the smallest N distances to the position 307 on the ground closest to the above ground location 304′ may then be selected as the subset of ground based locations 302.

In at least some examples, a subset of ground based locations 302 may be selected which each fall within a distance threshold of the position 307 on the ground closest to the above ground location 304′. For example, a distance 308 between each ground based location 302 and the position 307 on the ground closest to the above ground location 304′ may be calculated. The subset of ground based locations 302 may then be selected as all ground based locations for which the distance 308 between the ground based location 302 and the position 307 on the ground closest to the above ground location 304′ is less than a distance threshold.

In some examples, the subset of ground based locations 302 may be selected according to the direct distance between the above ground location 304′ and the ground based locations 302. For example, a direct distance between each ground based location 302 and the above ground location 304′ may be calculated. One such distance 309 between a ground based location 302 and the above ground location 304′ is labelled 309 in FIG. 3B. It will be appreciated that the direct distance 309 between a ground based location 302 and the above ground location 304′ may be different to the distance 308 between the ground based location 302 and the position 307 on the ground closest to the above ground location 304′ due to the difference in altitude between the position 307 and the above ground position 304′.

In some examples, the subset of ground based locations 302 may be selected as the N ground based locations 302 which are closest to the above ground location 304′, where N is an integer equal to or greater than one. That is, the N ground based locations 302 having the smallest N distances 309 to the above ground location 304′ may be selected as the subset of ground based locations 302.

In some examples, a subset of ground based locations 302 may be selected which each fall within a distance threshold of the above ground location 304′. For example, a distance 309 between each ground based location 302 and the above ground location 304′ may be calculated. The subset of ground based locations 302 may then be selected as all ground based locations 302 for which the distance 309 between the ground based location 302 and the above ground location 304′ is less than a distance threshold.

A number of different methods have been described above for selecting a subset of ground based locations 302 for a given above ground location 304. Generally, the subset of ground based locations 302 may be selected in dependence on their location relative to the given above ground location 304. For example, the selected subset of ground based locations 302 may represent locations which are closest (out of all of the available ground based locations 302) to the above ground location 304. In some examples, a predetermined number N of closest ground based locations 302 may be selected. In some examples, ground based locations 302 which lie within a distance threshold of the above ground location 304 may be selected.

In examples in which a distance threshold is used to select ground based locations, the number of ground based locations 302 included in the selected subset may be different for different above ground locations 304. For example, a first ground location 304 may have a first number of ground based locations 302 within a distance threshold of it, whereas a second above ground location 304 may have a second number of ground based locations 302 within a distance threshold of it, where the first number is different to the second number. In examples in which the N closest ground based locations 302 are selected for each above ground location 304, the number of ground based locations 302 included in the subset may be the same for each above ground location 304. In some examples, the subset may include a single ground based location 302 (e.g. in a scenario in which only a single ground based location 302 is situated within a distance threshold of the above ground location 304). In some examples, the subset may include a plurality of ground based locations 302.

At step 204 of FIG. 2, a plurality of training records are created. Each training record is associated with an above ground location 304. As was explained above, for each above ground location 304 a subset of ground based locations 302 was selected in step 203. Each training record may comprise at least the received data representative of the coverage of the mobile telecommunications network at the location above ground 304 with which the training record is associated and a subset of the data representative of coverage of the mobile telecommunications network at ground based locations 302. The subset of the data representative of coverage of the mobile telecommunications network at ground based locations 302 is formed of the data representative of coverage of the mobile telecommunications network at the subset of ground based locations 302 selected for the location above ground. That is, a subset of the data received at step 201 is selected to form part of a training data record for an above ground location 304, where the subset of the data relates to the subset of ground based locations 302 selected in step 203 for the above ground location 304.

As was explained above, the subset of ground based locations 302 is selected for each above ground location such that the network coverage at the above ground location 304 is related in some way to the network coverage at the selected subset of ground based locations 302. The subset of data included in each training data records therefore provide insight into the relationship between network coverage at ground based locations and an associated above ground location. As will be described in further detail below, the training data records may therefore be used to train a model to determine network coverage at an above ground location based on data representative of network coverage at ground based locations.

The training data records may be considered to comprise at least one input field and at least one output field. The at least one output field represents the desired output of a model trained using the training data. The at least one input field represents inputs to be provided to a trained model in order to determine the output of the model. In accordance with examples contemplated herein, the at least one output field of each training data record comprises the data representative of coverage of the mobile telecommunications network at the above ground location with which the training data record is associated. The at least one output field may comprise one or more numerical values (e.g. belonging to a continuous ranger of values) and/or may comprise one of more classifications such as one or more qualitive labels.

The at least one input field of each training data record comprises the data representative of network coverage at the subset of the ground based locations selected for the above ground location with which the data record is associated. The at least one input field further comprises at least one property of the above ground location. The at least one property of the above ground location may, for example, include an altitude of the above ground location, a longitude of the above ground location and/or a latitude of the above ground location.

As was explained above, the data representative of network coverage at ground based locations 302 and the data representative of network coverage at above ground locations 304 may include properties such as a received signal power (e.g. RSRP), received signal quality (e.g. RSRQ) and/or a timing advance at each location. An example training record may therefore include properties such as a received signal power (e.g. RSRP), received signal quality (e.g. RSRQ) and/or a timing advance for the above ground location with which the training record is associated. Such a training record may further include properties such as a received signal power (e.g. RSRP), received signal quality (e.g. RSRQ) and/or a timing advance for each of the subset of ground based locations selected for the above ground location with which the training record is associated.

As was explained above, the data representative of network coverage at ground based locations and/or above ground locations may include data associated with one or more cell. For example, the data may include properties such as a received signal power (e.g. RSRP), a received signal quality (e.g. RSRQ) and/or a timing advance associated with a serving or primary cell and may additionally include corresponding properties associated with other neighbouring cells. In at least some examples, data associated with a plurality of different cells may be included in the training data records. For example, the training data records may include properties indicative of network coverage (e.g. received signal quality, received signal power and/or a timing advance) provided by a serving or primary cell and one or more neighbouring cells. For at least some of the subset of ground based locations 302, the subset of the data representative of coverage of the mobile telecommunications network at ground based locations 302 may include data representative of coverage (e.g. received signal quality, received signal power and/or a timing advance) provided by a plurality of cells (e.g. a serving or primary cell and one or more neighbouring cells). The subset of the data may additionally include an identifier (e.g. a PCI) of the cell with which the data is associated. Additionally or alternatively, the data representative of coverage of the mobile telecommunications network at the above ground location with which the training data record is associated may include one or more properties of coverage (e.g. received signal quality, received signal power and/or a timing advance) provided by a plurality of cells (e.g. a serving or primary cell and one or more neighbouring cells). The data may additionally include an identifier (e.g. a PCI) of the cell with which the one or more properties is associated.

In some examples, the training data records may include additional data. For example, a training data record may include one or more further properties based on a geographical position of the above ground location and/or the geographical positions of the selected subset of ground based locations. A property based on a geographical position may include, for example, an altitude, a longitude and/or a latitude of a relevant location. For example, a training data record may at least include the altitude of the above ground location with which the training record is associated. The training data record may include further properties such as the latitude and longitude of the above ground location and/or the latitudes and longitudes of the subset of the ground based locations. However, since the subset of ground based locations is selected based on their locations relative to the above ground location, it may not be necessary to include further information related to the locations in the training data record.

In some examples, the training data records may include properties related to the relative geographic positions of the above ground location and the subset of ground based locations. For example, a measure of distance between the above ground location and the each of the subset of ground based locations may be determined and included in a training data record. As was explained above, a suitable measure of distance may comprise a direct distance between the above ground location and a ground based location. Additionally or alternatively, a suitable measure of distance may comprise a distance between a closest position on the ground to the above ground location and a ground based location. In some examples, the training data records may include a difference in altitude between the above ground location and each of the subset of ground based locations. In some examples, the training data records may include a measure of distance between the subset of ground based locations. For the purposes of forming training records, a measure of distance between locations may be more instructive for training purposes than the absolute geographic position of the locations.

In some examples, a process of feature engineering may be performed to generate further data to include in the training data records. The feature engineering may be based on the subset of data representative of coverage of the mobile telecommunications network at the subset of ground based locations and/or may be based on the data representative of network coverage at the above ground location with which the training record is associated. Feature engineering may derive one or more features based on a combination of features of the data representative of coverage at ground based locations and/or the above ground location. For example, one or more features may be derived based on more than one of features such as a received signal power, a received signal quality and a timing advance associated with a given location. Any features derived through feature engineering may be included in the training data records.

In some examples, one or more features derived through feature engineering may include proportions, ratios and/or products taken between different features. For example, for a given above ground location features may be derived for one or more of the selected subset of ground based locations such as a ratio between a received signal power (e.g. a serving cell RSRP) at a ground based location and a distance (D) between the above ground location and the ground based location. Such a feature may, for example, be derived as RSRP/(1+D). A further example of a possible feature may include a ratio between a received signal quality (e.g. a serving cell RSRQ) at a ground based location and a distance (D) between the above ground location and the ground based location. Such a feature may, for example, be derived as RSRQ/(1+D). A further example of a possible feature may include a product between a received signal power (e.g. a serving cell RSRP) at a ground based location and a distance (D) between the above ground location and the ground based location. Such a feature may, for example, be derived as RSRP*(1+D). A further example of a possible feature may include a product between a received signal quality (e.g. a serving cell RSRQ) at a ground based location and a distance (D) between the above ground location and the ground based location. Such a feature may, for example, be derived as RSRQ*(1+D). The above examples of possible features to include in a training data set are provided by way of example only it will be appreciated that additional or alternative features may be derived.

At step 205 of FIG. 2, a prediction model is trained using the plurality of training data records formulated at step 204. The prediction model is trained for determining above ground coverage of a mobile telecommunications network dependent on data representative of coverage of the mobile telecommunications network at a plurality of ground based locations. The prediction model may comprise a machine learning model. The training of the prediction model may comprise applying a supervised machine learning training algorithm to train the machine learning model.

As will be appreciated by those of ordinary skill in the art, supervised learning of a prediction model involves training the model to map an input to an output based on training data records. In this instance, the input to the prediction model comprises data representative of network coverage at a plurality of ground based locations and the output comprises data representative of network coverage at an above ground location. The training data records formed in step 204 forms the training data used in a supervised learning of the prediction model. Supervised training of the prediction model may comprise determining parameters of the prediction model which map the input fields of the training data records to the output fields of the training data records to a desired accuracy.

Any suitable prediction model and training algorithm may be used. In some examples, the prediction model comprises a regression model. For example, the output of the regression model may comprise one or more numerical values belonging to a continuous range of values. In some examples, the prediction model comprises a classification model. For example, the output of the classification model may comprise one or more classifications (e.g. in the form of qualitive labels) which are representative of network coverage.

Examples of suitable algorithms may include a K-nearest neighbour, a linear regression algorithm, a support vector machine (e.g. a support-vector clustering algorithm), a decision tree algorithm, a random forest algorithm, an adaptive boosting (AdaBoost) algorithm, a gradient boosting algorithm, a voting algorithm and/or a stacking algorithm. In some examples, a deep learning algorithm may be used to train an artificial neural network.

The output the training process typically comprises a plurality of determined parameters of the prediction model which best matches the input fields of the training data to the output fields of the training data. As will be described in further detail below, the determined parameters of the prediction model may be used to implement the prediction model to generate an output in dependence on inputs provided to the prediction model.

In at least some examples, the trained prediction model may be evaluated for accuracy. For example, a first subset of the available training records may be used to train the prediction model. A second subset of the available training records may then be used to evaluate the trained prediction model for accuracy. The evaluation of the trained prediction model may comprise providing the input fields of the second subset of the training records as inputs to the trained prediction model and implementing the trained prediction model to generate an output dependent on the inputs. The output of the prediction model may then be compared to output fields of the second subset of the training records.

If the trained prediction model had a perfect accuracy then the output of the implemented prediction model would match the output fields of the training records used to provide inputs to the prediction model. However, in practice no model has perfect accuracy and there will be some error difference between the model output and the output fields of the training records. The model error may be analysed and used to assess the accuracy of the trained prediction model. The trained model may then be used in regions where little or no measurements of above ground coverage are available to determine above ground coverage based on data representative of ground based coverage.

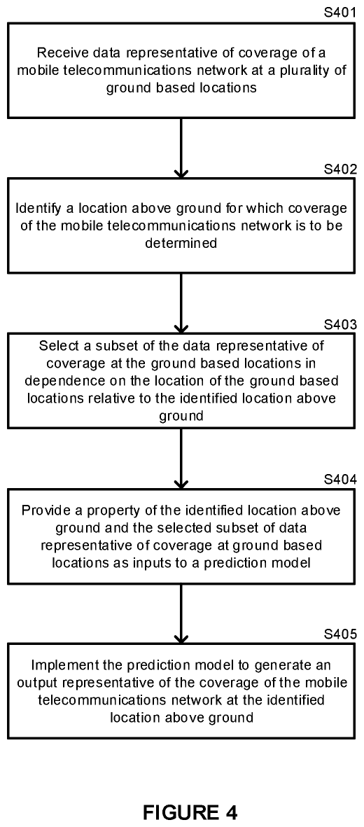

FIG. 4 is a flow chart of an example method for determining above ground coverage of a mobile telecommunications network using a trained prediction model. The method may be implemented on any suitable computing device. In some examples, each method step may be implemented on the same computing device. In other examples, different parts of the method may be implemented on different computing devices which may be in communication with each other.

The method of FIG. 4 may, for example, be implemented for a geographic region in which the above ground coverage of the network is not known but where data representative of the coverage at ground based locations is available (e.g. measurements of received signal at ground based locations have been made). The method therefore allows for the above ground coverage to be determined without the need for measurements to be made at above ground locations.

At step 401 of FIG. 4 data representative of coverage of a mobile telecommunications network at a plurality of ground based locations is received. Step 401 of the method of FIG. 4 is similar to step 201 of the method of FIG. 2 and the same features described in connection with step 201 of FIG. 2 may also apply to step 401 of FIG. 4.

As was explained above, data representative of coverage of a mobile telecommunications network may be measured or otherwise determined by terminals 104 operating in the network at ground based locations. For examples, terminals 104 operating in the network at ground based locations may measure signal received at the terminals 104. Terminals 104 situated at ground based locations may determine one or more properties such as a received signal power (e.g. RSRP), a received signal quality (e.g. RSRQ) and/or a timing advance. As was explained above, the one or more determined properties may be associated with a particular cell and/or base station. In some example, one or more of the determined properties (e.g. a received signal power, a received signal quality and/or a timing advance) may be determined for a plurality of different cells or base stations. The determined properties may be associated with an identifier of the cell or base station with which it is associated. For example, a determined property (e.g. a received signal power, a received signal quality and/or a timing advance) may be associated with a Physical Cell Identifier (PCI) of the cell with which the property is associated.

In some examples, a terminal 104 may measure or otherwise determine one or more properties such as a received signal power (e.g. RSRP), a received signal quality (e.g. RSRQ) and/or a timing advance for each of its serving cells (which may be a single serving cell or a plurality of serving cells). Additionally or alternatively a terminal 104 may measure or otherwise determine one or more properties such as a received signal power (e.g. RSRP), a received signal quality (e.g. RSRQ) and/or a timing advance for other neighbouring cells which are not a serving cell of the terminal 104.

The data representative of coverage of a mobile telecommunications network at a plurality of ground based locations may, for at least some of the ground based locations, include data representative of network coverage provided by a plurality of cells. For example, for at least some ground based locations, the data may include one or more properties indicative of network coverage provided by a serving or primary cell. For at least some ground based locations the data may include one or more properties indicative of network coverage provided by one or more additional cells, which may be neighbouring cells (e.g. to a serving or primary cell).

The data representative of coverage of a mobile telecommunications network which is received at step 401 may comprise measurements made by one or more terminals 104 (e.g. of received signal). Additionally or alternatively the data may comprise properties which are determined in dependence on measurements made by one or more terminals (e.g. of received signal). Receiving the data in step 401 may take any suitable form. For example, receiving the data may comprise reading the data from memory and/or receiving the data from another device at which the data is stored.

In the method of FIG. 4, the data received at step 401 is used to predict network coverage at a chosen above ground location by using the trained prediction model. At step 402 of FIG. 4 a location above ground is identified for which coverage of the mobile telecommunications network is to be determined. The identified location may be any location above ground for which the network coverage is to be determined. The identified location will typically be within a geographic range of ground based locations for which data was received at step 401. For example, the ground based locations for which data is received at step 401 may cover a range of latitudes and longitudes. The location above ground which is identified at step 402 may lie within the range of latitudes and longitudes covered by the ground based locations. This may ensure that sufficient ground based data is available in order to determine the network coverage at the identified above ground location.

The location above ground may be identified, for example, by way of a user input selecting an above ground location for which network coverage is to be determined. Additionally or alternatively, the location above ground may be identified, for example, by a software routine selecting a location above ground for which the network coverage is to be determined.

At step S403 of FIG. 4 a subset of the data representative of coverage at the plurality of ground based locations (received at step 401) is selected. The selected subset of the data comprises data representative of coverage of the mobile telecommunications network at a subset of the ground based locations. Step 403 may therefore comprise selecting a subset of the ground based locations and selecting the data representative of network coverage at the selected subset of ground based locations as the selected subset of the data. The subset of ground based locations is selected in dependence on their location relative to the identified location above ground.

The selection of a subset of ground based locations for an identified location above ground may be similar to the selection of a subset of ground based locations (for a given location above ground) as described above with reference to step 203 of FIG. 2. Any of the features described above with reference to step 203 of FIG. 2 may also apply to the selection of a subset of ground based locations in order to select a subset of the data representative of network coverage at step 403 of FIG. 4. For example, the selected subset of ground based locations may comprise locations at which the network coverage is determinative of the network coverage at the location above ground which was identified at step 402. The selected subset of ground based locations may correspond to locations which are near to and in the same vicinity as the identified location above ground.

In some examples, the subset of ground based locations may be selected as the N ground based locations which are closest to the identified above ground location, where N is an integer equal to or greater than one. That is, the N ground based locations having the smallest N distances to the identified above ground location may be selected as the subset of ground based locations.

In some examples, a subset of ground based locations may be selected which each fall within a distance threshold of the identified above ground location. For example, a distance between each ground based location and the identified above ground location may be calculated. The subset of ground based locations may then be selected as all ground based locations for which the distance between the ground based location and the identified above ground location is less than a distance threshold.

The selected subset of ground based locations is used to select a subset of the data representative of coverage of the ground based locations. For example, the subset of the data may be selected as the data which is representative of coverage at the selected subset of ground based locations.

At step 404 of FIG. 4, inputs are provided to a trained prediction model. The inputs include at least the selected subset of data selected at step 403 and at least one property of the identified location above ground. The prediction model is configured through training to determine coverage of a mobile telecommunications network at locations above ground in dependence on data representative of the network coverage at ground based locations. The prediction model may comprise a model trained using any of the methods described above with reference to FIG. 2.

In some examples, the prediction model comprises a regression model. For example, the output of the regression model may comprise one or more numerical values belonging to a continuous range of values. In some examples, the prediction model comprises a classification model. For example, the output of the classification model may comprise one or more classifications (e.g. in the form of qualitive labels) which are representative of network coverage.

The prediction model may comprise a machine learning model. The prediction model may have been trained by applying a supervised machine learning training algorithm to train the machine learning model. Any suitable prediction model and training algorithm may be used. Examples of suitable algorithms may include a K-nearest neighbour, a linear prediction algorithm, a support vector machine (e.g. a support-vector clustering algorithm), a decision tree algorithm, a random forest algorithm, an adaptive boosting (AdaBoost) algorithm, a gradient boosting algorithm, a voting algorithm and/or a stacking algorithm. In some examples, a deep learning algorithm may be used to train an artificial neural network.

The at least one property of the identified location above ground may comprise the altitude of the identified location above ground. In some examples, the at least one property of the identified location above ground may include additional or alternative properties of the identified location above ground such as the latitude and/or longitude of the identified location. However, since the subset of ground based locations is selected based on their locations relative to the above ground location, it may not be necessary to include further information related to identified location above ground in the inputs to the prediction model.

The inputs to the prediction model may generally correspond to input fields of the training data records used to train the prediction model. Corresponding properties to any of the properties described above as forming part of an input field of a training data record may therefore be included in inputs provided to the prediction model.

For example, inputs to the prediction model may include additional data such as one or more further properties based on a geographical position of the identified above ground location and/or the geographical positions of the selected subset of ground based locations. A property based on a geographical position may include, for example, an altitude, a longitude and/or a latitude of a relevant location. For example, an input to the prediction model may include further properties such as the latitude and longitude of the above ground location and/or the latitudes and longitudes of the subset of the ground based locations.

In some examples, the inputs to the prediction model may include properties related to the relative geographic positions of the identified above ground location and the subset of ground based locations. For example, a measure of distance between the identified above ground location and each of the subset of ground based locations may be determined and provided as an input to the prediction model. As was explained above, a suitable measure of distance may comprise a direct distance between the identified above ground location and a ground based location. Additionally or alternatively, a suitable measure of distance may comprise a distance between a closest position on the ground to the identified above ground location and a ground based location. In some examples, inputs to the prediction model may include a measure of distance between the subset of ground based locations.

In some examples, a process of feature engineering may be performed to generate further inputs to the prediction model. The feature engineering may be based on the subset of data representative of coverage of the mobile telecommunications network at the subset of ground based locations and/or may be based on the identified above ground location. Feature engineering may derive one or more features based on a combination of features of the data representative of coverage at ground based locations and/or the identified above ground location. For example, one or more features may be derived based on more than one of features such as a received signal power, a received signal quality and a timing advance associated with a given ground based location. Any features derived through feature engineering may be provided as an input to the prediction model.

In some examples, one or more features derived through feature engineering may include proportions, ratios and/or products taken between different features. For example, for a given above ground location features may be derived for one or more of the selected subset of ground based locations such as a ratio between a received signal power (e.g. a serving cell RSRP) at a ground based location and a distance (D) between the above ground location and the ground based location. Such a feature may, for example, be derived as RSRP/(1+D). A further example of a possible feature may include a ratio between a received signal quality (e.g. a serving cell RSRQ) at a ground based location and a distance (D) between the above ground location and the ground based location. Such a feature may, for example, be derived as RSRQ/(1+D). A further example of a possible feature may include a product between a received signal power (e.g. a serving cell RSRP) at a ground based location and a distance (D) between the above ground location and the ground based location. Such a feature may, for example, be derived as RSRP*(1+D). A further example of a possible feature may include a product between a received signal quality (e.g. a serving cell RSRQ) at a ground based location and a distance (D) between the above ground location and the ground based location. Such a feature may, for example, be derived as RSRQ*(1+D). The above examples of possible features to include as inputs to a prediction model are provided by way of example only it will be appreciated that additional or alternative features may be derived.

At step 405 of FIG. 4 the prediction model is implemented to generate an output representative of the coverage of the mobile telecommunications network at the identified location above ground. The output of the prediction model is dependent on the inputs provided at step 404.

The output of the prediction model may generally correspond to output fields of the training data records used to train the prediction model. Corresponding properties to any of the properties described above as forming part of an output field of a training data record may therefore be included in outputs provided by the prediction model. For example, the output of the prediction model may include one or more properties indicative of the coverage provided by the mobile telecommunications network at the identified location above ground. The one or more properties may include properties such as a received signal power (e.g. RSRP), received signal quality (e.g. RSRQ) and/or a timing advance. In some examples, (e.g. when the prediction model comprises a classification model), the output of the prediction model may comprise one or more classifications, such as qualitive labels, which are representative of network coverage. For example, the output of the prediction model may comprise labels such as “low”, “medium”, “high” and/or “bad”, “medium”, “good” etc. Such labels may be associated with a specific measure of network coverage such as signal power and/or signal quality or may provide a more general classification of network coverage. Such labels may be determined, for example, based on measurements of one or more properties indicative of network coverage.

The output of the prediction model may include one or more properties output for a single cell (e.g. a serving or primary cell) or for a plurality of cells. For example, one or more properties such as a received signal power, received signal quality and/or timing advance may be output for each of a plurality cells. The plurality of cells may include a primary cell and one or more secondary cells. Additionally or alternatively the plurality of cells may include one or more neighbouring cells to a primary or serving cell. In at least some examples, the output of the prediction model may include an indication of the cell to which the one or more properties relate. The indication of the cell may, for example, comprise a PCI.

As was explained above, the method of FIG. 4 may be carried out in order to determine a coverage provided by a mobile telecommunications network at the identified location above ground. In at least some examples, the method of FIG. 4 may be carried out and the prediction model implemented for a plurality of different locations above ground. For example, the method may be carried out for above ground locations at different altitudes. Additionally or alternatively the method may be carried out for above ground locations at different latitudes and/or longitudes. By carrying out the method for a plurality of different locations above ground, a map be constructed of the coverage provided by a mobile telecommunications network across a range of locations in the sky and without the need to measure the network coverage at the range of locations in the sky.

As was explained above, a determination of network coverage at above ground positions in the sky may have a range of different uses. For example, knowledge of the network coverage in the sky (which may be acquired using the methods described above) may be useful when operating a network connected device situated on an airborne platform, such as a network connected drone. In at least some examples, knowledge of the network coverage in the sky may be used to determine the position of airborne devices using network data alone, for example, as an alternative to using the Global Positioning System (GPS). For example, if one or more measures of network coverage (e.g. signal power, signal quality etc.) as a function of location above ground are determined using the methods described above, then measurements of corresponding properties taken by an airborne device may be used to accurately determine its location.

It has been found that the methods described herein are particularly effective at determining properties of network coverage at above ground locations. Furthermore, it has been found that the methods described herein are able to determine network coverage at above ground locations to a greater accuracy than one or more alternative modelling techniques. Other potential modelling techniques may include modelling based on knowledge of the position and/or properties of network components such as base stations. For example, knowledge of the position and/or properties of base stations used in the network could be used to model (e.g. using propagation modelling) the expected coverage provided by the base stations at positions which might include above ground positions. However, such modelling requires a detailed knowledge of the network components and the surrounding environment which change over time. Furthermore, such modelling may not capture local effects such as obstruction of signals by the aspects of the environment surrounding the base stations. For example, knowledge of the position and/or properties of base stations used in the network provides little information on how signals transmitted from the base stations will propagate through the surrounding environment.

The approach described herein in which measurements of network coverage made at ground based locations is used to determine coverage at above ground locations has been shown to successfully capture network conditions and the influence of the surrounding environment. In particular, the use of measurements of received signals includes information regarding the propagation of signals between different locations and has been found to successfully capture network conditions and the influence of the surrounding environment. For example, in some settings the presence of buildings and/or other features of a local environment may cause obstruction or distortion of signal transmitted over the network. This is particularly the case for radio signals transmitted using relatively high frequencies, such as those used in 5G NR implementations. Such effects may be very difficult to model when predicting network coverage. For example, local obstructions can cause large changes in network conditions with small changes in location which are not easily captured in models

However, it has been found that such effects are typically captured in measurements made at ground based locations (e.g. of received signal), such as the measurements routinely made by terminals operating in the network. The methods described herein in which such ground based measurements are used to determine above ground coverage have been found to successfully capture effects which may be poorly represented by other modelling approaches. For example, the use of ground based measurements has been found to successful capture the influence of local obstructions to radio signals when determining coverage at above ground locations since such influences are successfully captured in the ground based measurements (e.g. of received signal) used in the determination.

The accuracy of the methods described herein may be influenced by the data which is used to form the training data records used to train the prediction model. It may therefore be desirable to train the prediction model using sufficient training data records. Furthermore, it may be desirable to train the prediction model using training data records relating to a range of different conditions. For example, the relationship between ground based network coverage and above ground network coverage may be dependent on the presence and density of artificial structures such as buildings. The relationship between ground based network coverage and above ground network coverage may therefore be different in urban environments which include a relatively high density of artificial structures to rural environments which include a lower density of artificial structures. Furthermore, the relationship between ground based network coverage and above ground network coverage may be influenced by factors such as undulation of the ground level. For example, the relationship between ground based network coverage and above ground network coverage may be different in environments in which the ground level is relatively flat to environments which include relatively large undulations in the local ground level. Furthermore, the relationship between ground based network coverage and above ground network coverage may be influenced by factors such as weather conditions. The relationship between ground based network coverage and above ground network coverage may therefore be different in different weather conditions.

In at least some examples contemplated herein the data used to form the training data records may include data corresponding to a variety of different environments and/or conditions. For example, dedicated flights of an airborne platform may be flown in a variety of different environments and/or conditions in order to collect above ground coverage measurements in a variety of different environments and/or conditions for training purposes. For example, data may be collected in urban environments, rural environments, relatively flat environments and/or relatively undulating environments in order to form a diverse collection of training data records. Additionally or alternatively, data may be collected in different types of weather conditions in order to form a diverse collection of training data records. Using such a diverse collection of training data records to train a prediction model may improve the performance of the prediction model in determining above ground network coverage in a range of different environments and/or conditions.

Methods have been described above for training a prediction model and implementing a trained prediction model for determining network coverage at above ground locations. In order to illustrate the benefits of the methods described herein an illustrative example will now be described.

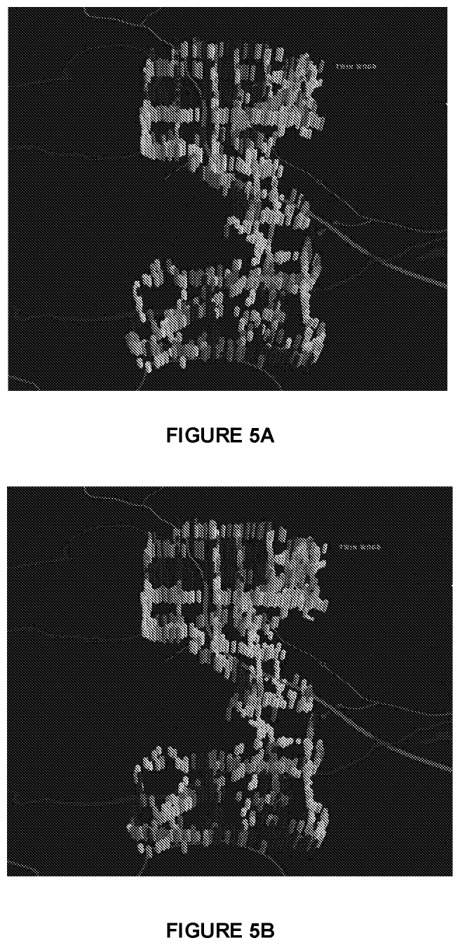

FIGS. 5A and 5B are representations of the results of a determination of network coverage at above ground locations which was carried out in a rural area of the UK. The area in which the determinations were made comprises an approximately 1.5 km×3 km region. A dedicated flight of a network connected drone was carried out in order to measure the network coverage at above ground locations. Measurements were also made in the same region by terminals situated at ground based locations. Network coverage measurements were made at a total of 4143 locations including both ground based and above ground locations.

Approximately two thirds of the measurements were used to train a prediction model for determining above ground coverage according to the methods described herein with reference to FIG. 2. In the depicted example, a random forest algorithm was used to train and implement the prediction model which took the form of a regression model.

The remaining one third of the measurements were used to evaluate the trained prediction model. The trained prediction model was evaluated by using measurements made at ground based locations to determine network coverage at above ground locations using the trained prediction model according to the methods described herein with reference to FIG. 3. The network coverage at above ground locations determined by using the trained prediction model was then compared to the measurements of network coverage made at the same above ground locations.

FIG. 5A is a representation of the network coverage determined at different above ground locations by using the trained prediction model. FIG. 5B is a corresponding representation of the measured network coverage at the same above ground locations for which the determined network coverage is shown in FIG. 5A. In both of FIGS. 5A and 5B the height of the pillars shown at different locations denote RSRP values at those locations. That is, in FIG. 5A the height of the pillars denote the RSRP values determined using the trained prediction model and in FIG. 5B the height of the pillars denote the RSRP values measured at the same above ground locations. In both of FIGS. 5A and 5B the shade of grey of the pillars shown at different locations denote RSRQ values at those locations. That is, in FIG. 5A the shade of grey of the pillars denote the RSRQ values determined using the trained prediction model and in FIG. 5B the shade of grey of the pillars denote the RSRQ values measured at the same above ground locations.

A simple comparison of FIGS. 5A and 5B show that the trained prediction model was successful to a high degree of accuracy at determining measures of network coverage (i.e. RSRP and RSRQ) based on network coverage measurements made at ground based locations.

It will be appreciated that according to different examples contemplated herein different features may be used to determine network coverage at above ground locations. For instance, in a first example a relatively small set of features may be used to train and implement a prediction model. In particular, when forming training data records for training a prediction model, a serving cell RSRP value, a serving cell RSRQ value and a distance between the ground based location and the location above ground may be used for each ground based location. That is, each training data record for a given above ground location may include data corresponding to N ground based locations. The data corresponding to each ground based location may include a serving cell RSRP value, a serving cell RSRQ value and a distance between the location above ground and the ground based location. Each training record may additionally include the altitude of the above ground location with which the training record is associated.

Similarly, when implementing the trained prediction model in the model evaluation stage, for each location above ground, input data may be provided for N nearest ground based locations. The input data for each ground based location may include a serving cell RSRP value, a serving cell RSRQ value and a distance between the location above ground and the ground based location. The input data may further include the altitude of the identified above ground location for which the network coverage is to be determined.

In the first example, a random forest algorithm or other suitable machine learning algorithm may be used to train and implement the prediction model using the data described above.

In a second illustrative example a larger group of features may be used to train and implement a prediction model. For example, in addition to the features described above in connection with the first example, a plurality of further features may be included in the training data records for each location above ground. In particular, each training data record for a given above ground location may include additional features for each of the N closest ground based locations for the above ground location. The additional features may include, a PCI of the serving cell, a timing advance for the serving cell and the longitude, latitude and altitude of the ground based location. Furthermore, each training record for a given above ground location may additionally include the longitude and latitude of the location above ground with which the training record is associated (as well as the altitude used in the first example).

Similarly, when implementing the trained prediction model in the model implementation stage of the second experiment, for each location above ground, input data may be provided for N nearest ground based locations. The input data for each ground based location may include, in addition to the data used for the first experiment, a PCI of the serving cell, a timing advance for the serving cell and the longitude, latitude and altitude of the ground based location. The input data may further include the latitude and longitude of the identified above ground location for which the network coverage is to be determined (as well as the altitude used in the first example).

In the second example, a random forest algorithm or other suitable machine learning algorithm may be used to train and implement the prediction model using the data described above.

Several examples have been described herein in which a regression model is trained and implemented to determine numerical values representative of network coverage. However, as also mentioned herein, a classification model may be used as an alternative to a prediction model. For example, a classification model may be trained and implemented to determine one or more qualitive labels which are representative of network coverage. For example, an output of a classification model may be in the form of one or more qualitive labels such as “low”, “medium”, “high” and/or “bad”, “medium”, “good” etc.

A classification model as contemplated herein may be configured to receive inputs representative of network coverage at ground based locations which are similar to or the same as corresponding inputs to a regression model as described herein. The outputs of a classification model may however differ from a regression model in that they may comprise qualitive classifications as opposed to numerical values belonging to a continuous range of values as with a regression model

A classification model may have utility in a subset of possible applications of the methods described herein. For example, a classification model may be used to determine above ground locations which experience poor network coverage. Such a determination could be used, for example, to determine locations in which not to fly a network connected drone. Such an application would not necessarily require the quantitative measure of network coverage output by a regression model and thus a classification model may be appropriate.

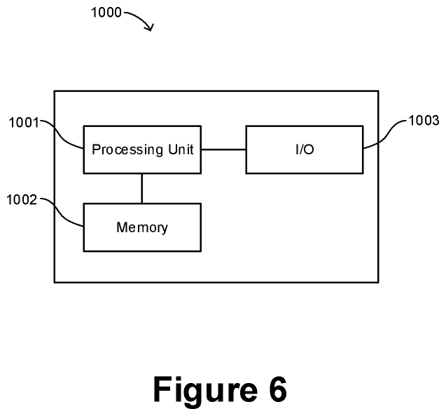

Various computer implemented methods and devices have been described above. In general any method described herein may be implemented on one or more electronic devices. FIG. 6 is a schematic illustration of an example electronic device which may be used to implement all or part of any method described herein. The general structure of the device depicted in FIG. 6 may be applicable to any terminal, base station and/or any other electronic device contemplated herein.

The device 1000 may include at least one processing unit 1001, memory 1002 and an input/output (I/O) interface 1000. The processing unit 1001 may include any suitable processer and/or combination of processors. For example, the processing unit 1001 may include one or more of a Central Processing Unit (CPU) and a Graphical Processing Unit (GPU). The memory 1002 may include volatile memory and/or non-volatile/persistent memory. The memory 1002 may, for example, be used to store data such as an operating system, instructions to be executed by the processing unit (e.g. in the form of software to be executed by the processing unit), configuration information related to the device 1000, session information and/or configuration or registration information associated with any other device, node or module in the network. For example, the memory 1002 may be used to store data representative of coverage of a mobile telecommunications network at one or more ground based or above ground locations. In some examples, the memory 1002 may be used to store instructions for executing any of the methods disclosed herein.

At least the processing unit 1001 is connected to an input/output (1/O) interface 1003. The I/O interface 100 facilitates communication with one or more other devices, network nodes or modules in a network. For example, the I/O interface 1003 may be operable to transmit and/or receive communications to/from other devices in a network. In some examples, the I/O interface 1003 may be operable to transmit and/or receive communications over an air interface. For example, the I/O interface 1003 may include a transmitter and/or a receiver for transmitting and/or receiving wireless communication (e.g. radio frequency signals). In some examples, the I/O interface 1003 may include a transceiver configured to receive and transmit wireless communication (e.g. radio frequency signals). In some examples, the I/O interface 1003 may be operable to additionally or alternatively communicate over one or more wired connections.

Optionally, the device 1000 may further include a display 1004. For example, where the device 1000 is a UE, the UE may include a display 1004 for displaying information to a user of the UE. The display 1004 may comprise any suitable electronic display such as a touch sensitive display. The display 1004 may be connected to at least to the processing unit 1001. The processing unit 1001 may generate display signals which are sent to the display 1004 in order to cause the display information.

In the interest of conciseness not all possible alternatives which fall within the scope of the present disclosure have been explicitly discussed herein. As the skilled person will appreciate, in the present disclosure any aspect discussed from the perspective of an element being operable to do an action also discloses the same feature from the perspective of a method including a method step corresponding to the action. Similarly, any discussion presented from the perspective of a method step also discloses the same features from the perspective of any one or more suitable elements being operable or configured to carry out some or all of the method step. It is also considered within the present disclosure that for any method step(s), there can be a computer program configured to carry out, when executed, the method step(s).

Within the context of the present disclosure a device, such as a terminal, a base station, or a network module or node, is generally considered from a logical perspective, as the element carrying out the appropriate function. Any such device may be implemented using one or more physical elements as deemed appropriate. For example, it may be implemented in one (or more) of: a standalone physical device, in two or more separate physical devices, in a distributed system, in a virtual environment using any suitable hardware or hardware combination, etc.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples. The invention extends to any novel one, or any novel combination, of the features disclosed in this specification (including any accompanying claims, abstract and drawings), or to any novel one, or any novel combination, of the steps of any method or process so disclosed.

1. A computer implemented method of determining above ground coverage of a mobile telecommunications network, the method comprising:
receiving data representative of coverage of the mobile telecommunications network at a plurality of ground based locations;
identifying a location above ground for which coverage of the mobile telecommunications network is to be determined;
selecting a subset of the data representative of coverage at the plurality of ground based locations, wherein the subset comprises data representative of coverage of the mobile telecommunications network at a subset of the ground based locations and wherein selecting the subset comprises selecting the subset of the ground based locations in dependence on their location relative to the identified location above ground;
providing a property of the identified location above ground and the selected subset of data representative of coverage at ground based locations as inputs to a prediction model, configured through training, to determine coverage of a mobile telecommunications network at locations above ground in dependence on data representative of coverage of the mobile telecommunications network at one or more ground based locations; and
implementing the prediction model to generate an output in dependence on the provided inputs, wherein the output of the model is representative of the coverage of the mobile telecommunications network at the identified location above ground.

2. The method of claim 1, wherein selecting the subset of the ground based locations in dependence on their location relative to the identified location above ground comprises: selecting a subset of N ground based locations which are the N closest of the plurality of ground based locations to the identified location above ground, wherein N is an integer equal to or greater than 1.

3. The method of claim 1, wherein selecting the subset of the ground based locations in dependence on their location relative to the identified location above ground comprises: selecting all of the ground based locations which are positioned within a distance threshold of the identified location above ground.

4. The method of claim 1, wherein the data representative of coverage of the mobile telecommunications network at a plurality of ground based locations is based on measurements indicative of coverage of the mobile telecommunications made at a plurality of ground based locations.

5. The method of claim 1, wherein the prediction model is configured through supervised training using a plurality of training data records, the plurality of training data records being derived from measurements indicative of the coverage of a mobile telecommunications made at both ground based and above ground locations.

6. The method of claim 1, wherein the selected subset of data representative of coverage at the subset of ground based locations comprises at least one of a received signal power, a received signal quality and a timing advance at each of the subset of the ground based locations.

7. The method of claim 1, wherein the selected subset of data representative of coverage at the plurality of ground based locations comprises data representative of network coverage provided by a serving cell at each of the subset of the ground based locations.

8. The method of claim 1, wherein the selected subset of data representative of coverage at the subset of ground based locations comprises data representative of network coverage provided by a plurality of cells at each of the subset of the ground based locations.

9. The method of claim 1, further comprising providing at least one further input to the prediction model, wherein the at least one further input is based on the geographical position of the identified location above ground and/or the geographical positions of the selected subset of the ground based locations.

10. The method of claim 1, further comprising performing feature engineering based on the selected subset of data representative of coverage at ground based locations to determine at least one further input to the prediction model.

11. An apparatus for determining above ground coverage of a mobile telecommunications network, the apparatus comprising:
one or more processors; and
memory storing:
a prediction model configured through training, to determine coverage of a mobile telecommunications network at locations above ground in dependence on data representative of coverage of the mobile telecommunications network at a plurality of ground based locations; and
instructions which, when executed by the one or more processors, cause the apparatus to:
receive data representative of coverage of the mobile telecommunications network at a plurality of ground based locations;
identify a location above ground for which coverage of the mobile telecommunications network is to be determined;
select a subset of the data representative of coverage at ground based locations, wherein the subset comprises data representative of coverage of the mobile telecommunications network at a subset of the ground based locations and wherein selecting the subset comprises selecting the subset of the ground based locations in dependence on their location relative to the identified location above ground;
provide a property of the identified location above ground and the selected subset of data representative of coverage at ground based locations as inputs to the prediction model; and
implement the prediction model to generate an output in dependence on the provided inputs, wherein the output of the model is representative of the coverage of the mobile telecommunications network at the identified location above ground.

12. A computer implemented method of training a prediction model for determining above ground coverage of a mobile telecommunications network, the method comprising:
receiving data representative of coverage of the mobile telecommunications network at a plurality of ground based locations;
receiving data representative of coverage of the mobile telecommunications network at a plurality of locations above ground;
for each of the plurality of locations above ground, selecting a subset of the ground based locations in dependence on their location relative to the location above ground;
forming a plurality of training data records, each training data record being associated with a location above ground and comprising the received data representative of the coverage of the mobile telecommunications network at the location above ground and a subset of the data representative of coverage of the mobile telecommunications at ground based locations, wherein the subset of the data comprises data representative of coverage of the mobile telecommunications network at the subset of ground based locations selected for the location above ground; and
training the prediction model for determining above ground coverage of a mobile telecommunications network using the plurality of training data records.

13. The method of claim 12, wherein selecting the subset of the ground based locations in dependence on their location relative to the location above ground comprises: selecting a subset of N ground based locations which are the N closest of the plurality of ground based locations to the location above ground, wherein N is an integer equal to or greater than 1.

14. The method of claim 12, wherein selecting the subset of the ground based locations in dependence on their location relative to the location above ground comprises: selecting all of the ground based locations which are positioned within a distance threshold of the location above ground.

15. The method of claim 12, wherein the data representative of coverage of the mobile telecommunications network at a plurality of ground based locations is based on measurements indicative of coverage of the mobile telecommunications made at a plurality of ground based locations.

16. The method of claim 12, wherein the data representative of coverage of the mobile telecommunications network at a plurality of locations above ground is based on measurements indicative of coverage of the mobile telecommunications made at a plurality of locations above ground.

17. The method of claim 12, wherein the received data representative of coverage at the plurality of ground based locations and/or the received data representative of coverage at the plurality of locations above ground comprises at least one of a received signal power, a received signal quality and a timing advance at each of the locations.

18. The method of claim 12, wherein the received data representative of coverage at the plurality of ground based locations and/or the received data representative of coverage at the plurality of locations above ground comprises data representative of network coverage provided by a serving cell at each of the locations.

19. The method of claim 12, wherein the received data representative of coverage at the plurality of ground based locations and/or the received data representative of coverage at the plurality of locations above ground comprises data representative of network coverage provided by a plurality of cells at each of the locations.

20. The method of claim 12, wherein at least one training record of the plurality of training records further comprises at least one property based on the geographical position of the location above ground and/or the geographical positions of the selected subset of the ground based locations.

21. The method of claim 12, further comprising performing feature engineering based on the selected subset of data representative of coverage at ground based locations to determine at least one further field of a training data record.

22. An apparatus for training a prediction model for determining above ground coverage of a mobile telecommunications network, the apparatus comprising:
one or more processors; and
memory storing instructions which, when executed by the one or more processors, cause the apparatus to:
receive data representative of coverage of the mobile telecommunications network at a plurality of ground based locations;
receive data representative of coverage of the mobile telecommunications network at a plurality of locations above ground;
for each of the plurality of locations above ground, select a subset of the ground based locations in dependence on their location relative to the location above ground;
form a plurality of training data records, each training data record being associated with a location above ground and comprising the received data representative of the coverage of the mobile telecommunications network at the location above ground and a subset of the data representative of coverage of the mobile telecommunications at ground based locations, wherein the subset of the data comprises data representative of coverage of the mobile telecommunications network at the subset of ground based locations selected for the location above ground; and
training the prediction model for determining above ground coverage of a mobile telecommunications network using the plurality of training data records.

23. (canceled)
